(19) United States
(12) Patent Application Publication
(10) Pub. No.: US 2026/0208503 A1
(43) Pub. Date: Jul. 23, 2026

(54) LIGHT IRRADIATOR AND PRINTING APPARATUS

(71) Applicant: KYOCERA Corporation, Kyoto-shi, Kyoto (JP)

(72) Inventor: Yuki DOI, Tachikawa-shi, Tokyo (JP)

(21) Appl. No.: 19/131,951

(22) PCT Filed: Nov. 10, 2023
(86) PCT No.: PCT/JP2023/040525

§ 371 Date: May 22, 2025

(30) Foreign Application Priority Data
Nov. 24, 2022 (JP) 2022-187077

(51) Int. Cl. B41J 11/00; B41J 29/377

(52) U.S. Cl. CPC B41J 11/00218; B41J 29/377

(57) ABSTRACT

A light irradiator includes: a light source; a heat dissipator; a drive; and a housing. The heat dissipator is thermally connected to the light source. The drive is a part for driving the light source. The light source, the heat dissipator, and the drive are arranged in the housing. The housing includes an inlet and an outlet. The heat dissipator is adjacent to the inlet. The outlet and the drive are each located on an opposite side of the heat dissipator from the light source.

### CROSS-REFERENCE TO RELATED APPLICATION

The present application is a National Phase of International Application No. PCT/JP2023/040525 filed Nov. 10, 2023, which claims priority to Japanese Patent Application No. 2022-187077 filed on Nov. 24, 2022, the entire disclosure of which is incorporated herein by reference.

The present disclosure relates to a light irradiator and a printing apparatus.

### BACKGROUND

A light irradiator may include a light source and a substrate for driving the light source, both accommodated in a housing (refer to, for example, Japanese Unexamined Patent Application Publication No. 2020-202346 and Japanese Patent No. 6761148).

The light irradiator includes, as the light source, lamps or light-emitting diodes (LEDs) that emit light in a specific wavelength range such as ultraviolet light or infrared light. Such a light irradiator is used in, for example, a printing apparatus that prints on a recording medium (also referred to as a print medium) such as a paper sheet using photocurable inks, such as ultraviolet curable inks (also referred to as UV inks), that are cured by ultraviolet irradiation (also referred to as photocuring).

Recent light irradiators are to be smaller and to have a simpler structure, fewer failures, and higher cooling performance.

### SUMMARY

One or more aspects of the present disclosure are directed to a light irradiator and a printing apparatus.

In one aspect, a light irradiator includes: a light source; a heat dissipator; a drive; and a housing. The heat dissipator is thermally connected to the light source. The drive is a part for driving the light source. The light source, the heat dissipator, and the drive are arranged in the housing. The housing includes an inlet and an outlet. The heat dissipator is adjacent to the inlet. The outlet and the drive are each located on an opposite side of the heat dissipator from the light source.

In one aspect, a printing apparatus includes: the light irradiator according to the above-mentioned one aspect; a mount; and a printing unit. The light irradiator is fastened to the mount. The printing unit prints on a print medium. The housing is in contact with the mount.

In another aspect, a light irradiator includes: a light source; a heat dissipator; and a housing. The heat dissipator is thermally connected to the light source. The light source and the heat dissipator are arranged in the housing. The housing includes: a first surface; a second surface facing the first surface; an inlet in the first surface; and an outlet in the first surface. The heat dissipator is adjacent to the inlet and is in contact with each of the first surface and the second surface. The outlet is located on an opposite side of the heat dissipator from the light source.

In another aspect, a printing apparatus includes: the light irradiator according to the above-mentioned other aspect; a mount; and a printing unit. The light irradiator is fastened to the mount. The printing unit prints on a print medium. The housing is in contact with the mount.

### BRIEF DESCRIPTION OF THE DRAWINGS

FIG. 1 is a front view of a light irradiator according to a first embodiment, illustrating its appearance.

FIG. 2 is a left side view of the light irradiator according to the first embodiment, illustrating its appearance.

FIG. 3 is a right side view of the light irradiator according to the first embodiment, illustrating its appearance.

FIG. 4 is a plan view of the light irradiator according to the first embodiment, illustrating its appearance.

FIG. 5 is a bottom view of the light irradiator according to the first embodiment, illustrating its appearance.

FIG. 6 is a perspective view of the light irradiator according to the first embodiment, illustrating its appearance.

FIG. 7 is a perspective view of the light irradiator according to the first embodiment, illustrating its appearance.

FIG. 8 is a schematic imaginary example cross-sectional view of the light irradiator taken along VIII-VIII in FIGS. 2 to 5 when viewed in a positive Y-direction.

FIG. 9 is a left side view of an example heat dissipator, illustrating its appearance.

FIG. 10 is a front view of the example heat dissipator, illustrating its appearance.

FIG. 11 is a schematic cross-sectional view of the light irradiator according to the first embodiment, illustrating passages of air.

FIG. 12 is a graph showing example relationships between the lighting time of light-emitting diode (LED) elements, the temperature of the LED elements, and the illuminance of LED light obtained in an experiment.

FIG. 13 is a left side view of an example light irradiator including a second opening having a first height in a first direction, illustrating its appearance.

FIG. 14 is a left side surface view of an example light irradiator including the second opening having a second height in the first direction, illustrating its appearance.

FIG. 15 is a left side surface view of an example light irradiator including the second opening having a third height in the first direction, illustrating its appearance.

FIG. 16 is a graph showing example simulation results for the relationship between the height of the second opening and the temperature reached by the LED elements being on.

FIG. 17 is a schematic diagram of a printing apparatus according to the first embodiment.

FIG. 18 is a plan view of examples of four types of inks applied to an upper surface of a print medium.

FIG. 19 is a front view of an example light irradiator fastened to a mount in the printing apparatus.

FIG. 20 is a right side view of a light irradiator according to another example of the first embodiment, illustrating its appearance.

FIG. 21 is a right side view of another example heat dissipator, illustrating its appearance.

FIG. 22 is a front view of the other example heat dissipator, illustrating its appearance.

FIG. 23 is a front view of another example light irradiator fastened to the mount in the printing apparatus.

### DETAILED DESCRIPTION

A light irradiator may include a light source and a substrate for driving the light source, both accommodated in a housing. The light irradiator includes, as the light source, lamps or light-emitting diodes (LEDs) that emit light in a specific wavelength range such as ultraviolet light or infrared light.

Such a light irradiator may be used in, for example, a printing apparatus that prints on a print medium such as a paper sheet using photocurable inks, such as ultraviolet curable inks (UV inks), that are cured by ultraviolet irradiation (photocuring). In the printing apparatus, for example, the light irradiator may irradiate, with ultraviolet light, the UV inks applied on the print medium in dots by, for example, inkjet printing.

The light source and electronic components on the substrate in the light irradiator described above generate heat in emitting light. The light source and the electronic components may thus be cooled with, for example, a heat dissipator (also referred to as a heat sink) and a cooling fan.

However, the light irradiator including, for example, a cooling fan can be large and have a complicated structure. For example, the cooling fan that is driven to rotate may have a failure. In the printing apparatus, for example, turbulence that may be forcibly caused by the cooling fan may affect ejection of the UV inks onto the print medium by, for example, inkjet printing and droplets of the UV inks reaching the print medium.

A light irradiator is thus to be smaller and to have a simpler structure and fewer failures, as well as to have higher cooling performance.

The inventor of the present disclosure has conceived a technique for a light irradiator to be smaller and to have a simpler structure and fewer failures, as well as to have higher cooling performance.

A first embodiment and examples of the first embodiment will now be described with reference to the drawings.

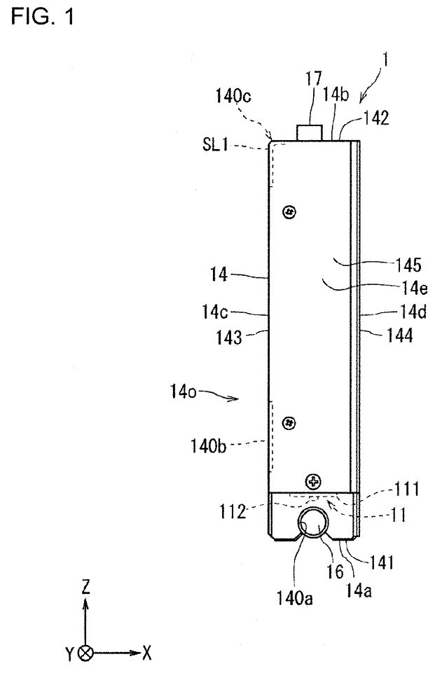

In the drawings, like reference numerals denote the components with like or similar structures and functions. Such components will not be described repeatedly. The drawings schematically illustrate various structures. FIGS. 1 to 11, 13 to 15, and 17 to 23 each illustrate a right-handed XYZ coordinate system. In the XYZ coordinate system, a direction (also referred to as an emission direction) in which a light irradiator 1 emits light is a negative Z-direction, a first direction opposite the emission direction is a positive Z-direction, a second direction being a thickness direction of the light irradiator 1 is a positive X-direction, and a direction being a width direction of the light irradiator 1 is a positive Y-direction. Although the second direction is hereafter the positive X-direction, the second direction may be a negative X-direction. Note that, in one or more embodiments of the present disclosure, the directional terms such as “up”, “down”, “right”, and “left” are used for clarity without limiting the structures and operating principles of the light irradiator 1 and a printing apparatus 100.

### 1. First Embodiment

### 1-1. Structure of Light Irradiator

The light irradiator 1 irradiates a target (also referred to as an irradiation target) with light. In one or more embodiments of the present disclosure, the light irradiator 1 is a light irradiator (also referred to as a fanless light irradiator) including no cooling fan (blower) for cooling, for example, a light source 11. The light irradiator (fanless light irradiator) including no fan (blower) includes a light irradiator including no fan (blower) in the internal space of a housing 14, a light irradiator including no fan (blower) in contact with an exterior of the housing 14, and a light irradiator including no fan (blower) in an opening in the housing 14. In other words, the fanless light irradiator may be a light irradiator including no fan (blower) in the internal space of the housing 14, at a position in contact with the exterior of the housing 14, or in the opening in the housing 14. For example, the light irradiator 1 can irradiate the target with light in a specific wavelength range.

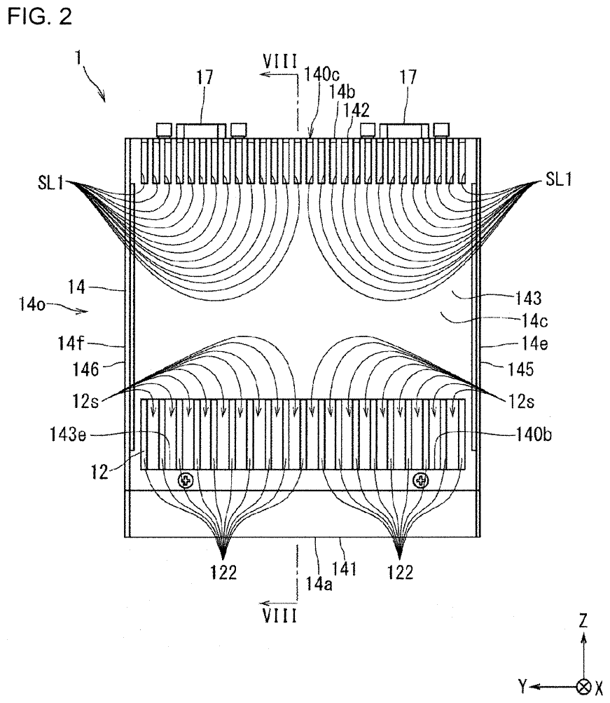

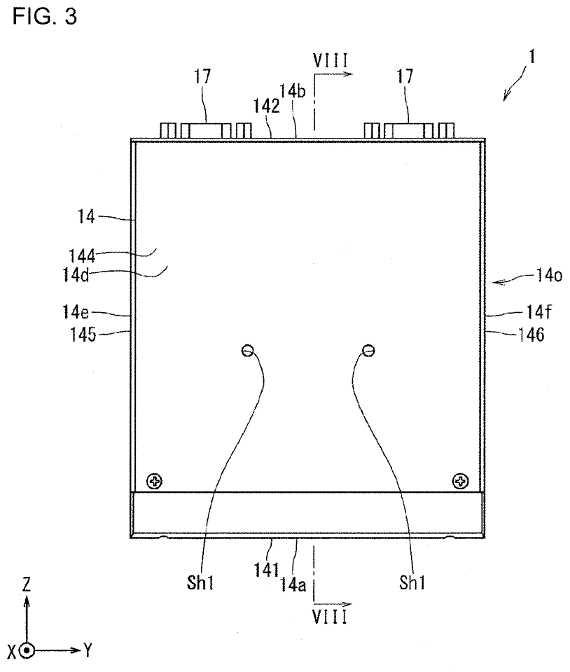

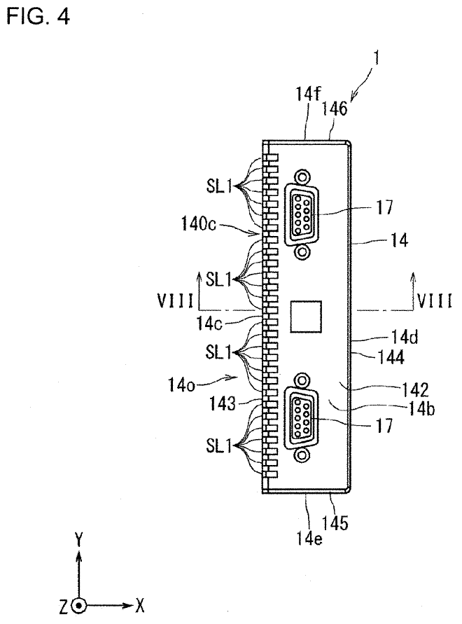

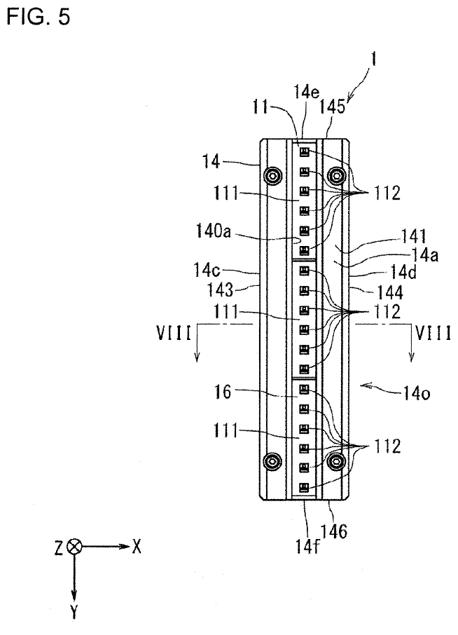

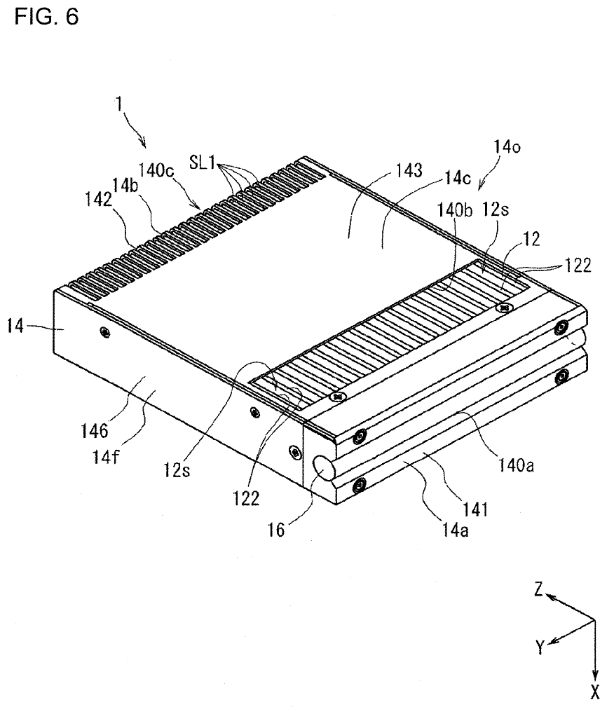

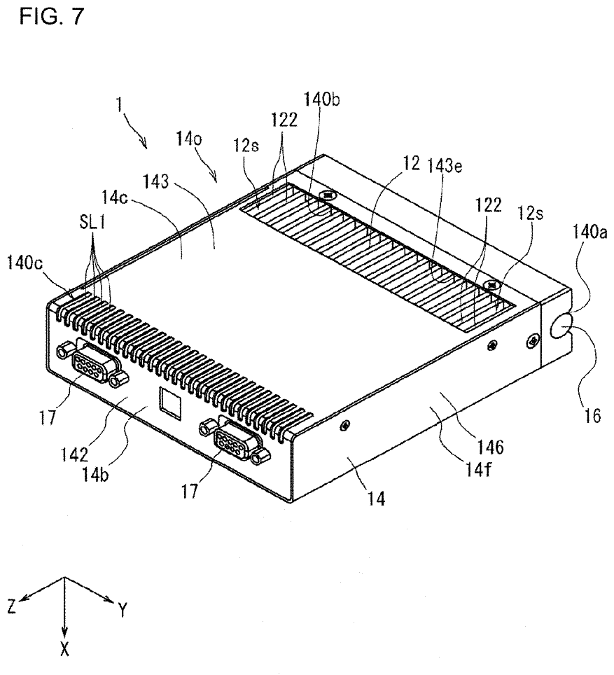

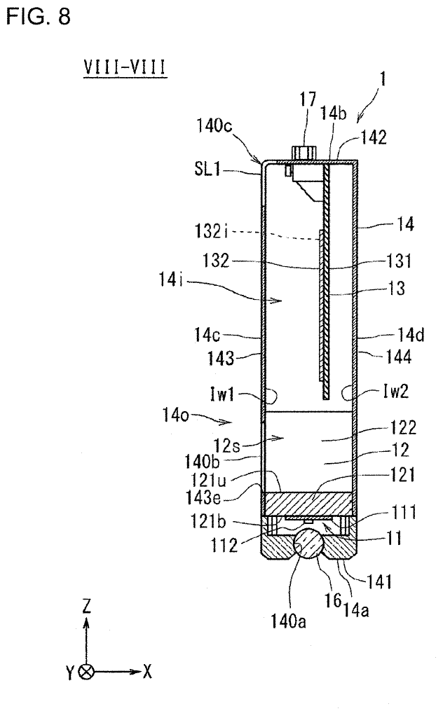

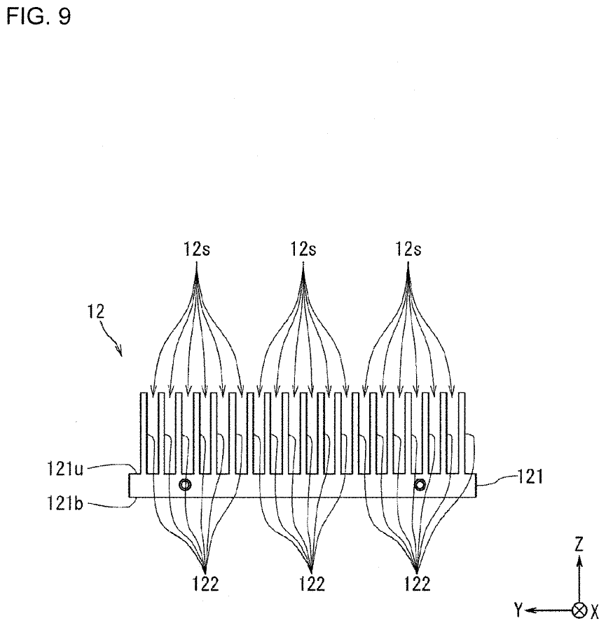

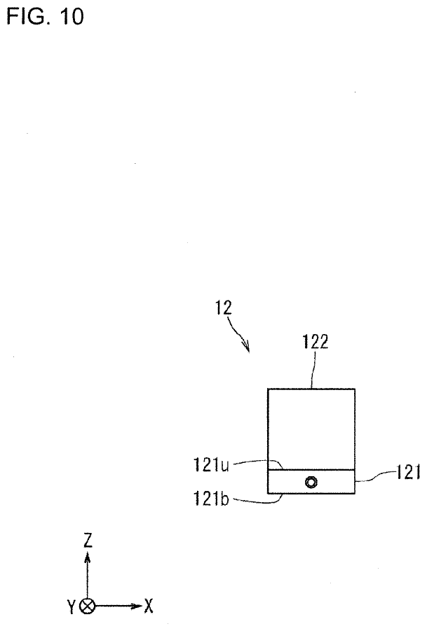

FIG. 1 is a front view of the light irradiator 1 according to the first embodiment, illustrating its appearance. FIG. 2 is a left side view of the light irradiator 1 according to the first embodiment, illustrating its appearance. FIG. 3 is a right side view of the light irradiator 1 according to the first embodiment, illustrating its appearance. FIG. 4 is a plan view of the light irradiator 1 according to the first embodiment, illustrating its appearance. FIG. 5 is a bottom view of the light irradiator 1 according to the first embodiment, illustrating its appearance. FIG. 6 is a perspective view of the light irradiator 1 according to the first embodiment, illustrating its appearance. FIG. 7 is a perspective view of the light irradiator 1 according to the first embodiment, illustrating its appearance. FIG. 8 is a schematic imaginary example cross-sectional view of the light irradiator 1 taken along VIII-VIII in FIGS. 2 to 5 when viewed in the positive Y-direction. FIG. 9 is a left side view of an example heat dissipator 12, illustrating its appearance. FIG. 10 is a front view of the example heat dissipator 12, illustrating its appearance. To indicate the positions of a second opening 140b, a third opening 140c, and the light source 11 in FIG. 1, the positions of the outer edges of the second opening 140b, the third opening 140c, and the light source 11 are schematically illustrated by the thin dashed lines as hidden lines. More specifically, in FIG. 1, the positions of the outer edges of a slit SL1 in the third opening 140c and a substrate 111 and a light emitter 112 in the light source 11 are schematically illustrated by the thin dashed lines as hidden lines.

As illustrated in FIGS. 1 to 8, the light irradiator 1 includes the light source 11, the heat dissipator (also referred to as a heat sink) 12, a drive 13, and the housing 14. The light source 11 includes multiple light emitters 112. The heat dissipator 12 is thermally connected to the light source 11. The drive 13 includes a circuit (also referred to as a drive circuit) 132 to drive the light source 11. The housing 14 is a rectangular prism and accommodates the light source 11, the heat dissipator 12, and the drive 13. In the example in FIGS. 1 to 8, the light irradiator 1 includes an optical system 16 and connectors 17.

### Housing 14

The housing 14 defines the external shape of the light irradiator 1. The housing 14 includes a rectangular first outer surface 14a, a rectangular second outer surface 14b, a quadrangular third outer surface 14c, a quadrangular fourth outer surface 14d, a rectangular fifth outer surface 14e, and a rectangular sixth outer surface 14f. The second outer surface 14b is opposite the first outer surface 14a of the housing 14. The third outer surface 14c connects the first outer surface 14a and the second outer surface 14b of the housing 14. The fourth outer surface 14d is opposite the third outer surface 14c of the housing 14. The fourth outer surface 14d connects the first outer surface 14a and the second outer surface 14b. The fifth outer surface 14e connects the first outer surface 14a and the second outer surface 14b of the housing 14, and connects the third outer surface 14c and the fourth outer surface 14d. The sixth outer surface 14f is opposite the fifth outer surface 14e of the housing 14. The sixth outer surface 14f connects the first outer surface 14a and the second outer surface 14b, and connects the third outer surface 14c and the fourth outer surface 14d.

The first outer surface 14a includes, for example, a pair of long sides (also referred to as first long sides) each extending in the positive Y-direction and a pair of short sides (also referred to as first short sides) each extending in the positive X-direction. In the example in FIGS. 1 to 8, the first outer surface 14a faces in the negative Z-direction. In other words, the first outer surface 14a is located along an imaginary plane parallel to an XY plane.

The second outer surface 14b includes, for example, a pair of long sides (also referred to as second long sides) each extending in the positive Y-direction and a pair of short sides (also referred to as second short sides) each extending in the positive X-direction. In the example in FIGS. 1 to 8, the second outer surface 14b faces in the positive Z-direction. In other words, the second outer surface 14b is located along an imaginary plane parallel to the XY plane.

The first outer surface 14a and the second outer surface 14b may be symmetric to each other with respect to, for example, an imaginary plane (also referred to as a first symmetry plane) along an imaginary plane parallel to the XY plane. In other words, for example, the first long sides and the second long sides may have the same dimension, and the first short sides and the second short sides may have the same dimension.

The third outer surface 14c includes, for example, two sides (also referred to as first sides) facing each other and each extending in the positive Z-direction and two sides (also referred to as second sides) facing each other and each extending in the positive Y-direction. In the example in FIGS. 1 to 8, the third outer surface 14c faces in the negative X-direction. In other words, the third outer surface 14c is located along an imaginary plane parallel to a YZ plane. Of the two second sides, one second side in the negative Z-direction may be the same as one first long side in the negative X-direction of the pair of first long sides or may be located along one first long side in the negative X-direction. Of the two second sides, the other second side in the positive Z-direction may be the same as one second long side in the negative X-direction of the pair of second long sides or may be located along one second long side in the negative X-direction.

The fourth outer surface 14d includes, for example, two sides (also referred to as third sides) facing each other and each extending in the positive Z-direction and two sides (also referred to as fourth sides) facing each other and each extending in the positive Y-direction. In the example in FIGS. 1 to 8, the fourth outer surface 14d faces in the positive X-direction. In other words, the fourth outer surface 14d is located along an imaginary plane parallel to the YZ plane. Of the two fourth sides, one fourth side in the negative Z-direction may be the same as the other first long side in the positive X-direction of the pair of first long sides or may be located along the other first long side in the positive X-direction. Of the two fourth sides, the other fourth side in the positive Z-direction may be the same as the other second long side in the positive X-direction of the pair of second long sides or may be located along the other second long side in the positive X-direction.

The third outer surface 14c and the fourth outer surface 14d may be symmetric to each other with respect to, for example, an imaginary plane (also referred to as a second symmetry plane) along an imaginary plane parallel to the YZ plane. In other words, for example, the first sides and the third sides may have the same dimension, and the second sides and the fourth sides may have the same dimension.

The fifth outer surface 14e includes, for example, a pair of long sides (also referred to as third long sides) each extending in the positive Z-direction and a pair of short sides (also referred to as third short sides) each extending in the positive X-direction. In the example in FIGS. 1 to 8, the fifth outer surface 14e faces in the negative Y-direction. In other words, the fifth outer surface 14e is located along an imaginary plane parallel to an XZ plane. Of the pair of third long sides, one third long side in the negative X-direction may be the same as one first side in the negative Y-direction of the two first sides or may be located along one first side in the negative Y-direction. Of the pair of third long sides, the other third long side in the positive X-direction may be the same as one third side in the negative Y-direction of the two third sides or may be located along one third side in the negative Y-direction. Of the pair of third short sides, one third short side in the negative Z-direction may be the same as one first short side in the negative Y-direction of the pair of first short sides or may be located along one first short side in the negative Y-direction. Of the pair of third short sides, the other third short side in the positive Z-direction may be the same as one second short side in the negative Y-direction of the pair of second short sides or may be located along one second short side in the negative Y-direction.

The sixth outer surface 14f includes, for example, a pair of long sides (also referred to as fourth long sides) each extending in the positive Z-direction and a pair of short sides (also referred to as fourth short sides) each extending in the positive X-direction. In the example in FIGS. 1 to 8, the sixth outer surface 14f faces in the positive Y-direction. In other words, the sixth outer surface 14f is located along an imaginary plane parallel to the XZ plane. Of the pair of fourth long sides, one fourth long side in the negative X-direction may be the same as the other first side in the positive Y-direction of the two first sides or may be located along the other first side in the positive Y-direction. Of the pair of fourth long sides, the other fourth long side in the positive X-direction may be the same as the other third side in the positive Y-direction of the two third sides or may be located along the other third side in the positive Y-direction. Of the pair of fourth short sides, one fourth short side in the negative Z-direction may be the same as the other first short side in the positive Y-direction of the pair of first short sides or may be located along the other first short side in the positive Y-direction. Of the pair of fourth short sides, the other fourth short side in the positive Z-direction may be the same as the other second short side in the positive Y-direction of the pair of second short sides or may be located along the other second short side in the positive Y-direction.

The fifth outer surface 14e and the sixth outer surface 14f may be symmetric to each other with respect to, for example, an imaginary plane (also referred to as a third symmetry plane) along an imaginary plane parallel to the XZ plane. In other words, for example, the third long sides and the fourth long sides may have the same dimension, and the third short sides and the fourth short sides may have the same dimension.

The first short sides of the first outer surface 14a, the second short sides of the second outer surface 14b, the third short sides of the fifth outer surface 14e, and the fourth short sides of the sixth outer surface 14f each have a dimension (also referred to as a first dimension) corresponding to, for example, the thickness of the housing 14. The first long sides of the first outer surface 14a, the second long sides of the second outer surface 14b, the second sides of the third outer surface 14c, and the fourth sides of the fourth outer surface 14d each have a dimension (also referred to as a second dimension) corresponding to, for example, the width of the housing 14. The first sides of the third outer surface 14c, the third sides of the fourth outer surface 14d, the third long sides of the fifth outer surface 14e, and the fourth long sides of the sixth outer surface 14f each have a dimension (also referred to as a third dimension) corresponding to, for example, the height of the housing 14.

The housing 14 has an external shape of a thin rectangular prism. The housing 14 may have dimensions determined as appropriate for, for example, the specifications and the use of the light irradiator 1. For example, the first short sides of the first outer surface 14a, the second short sides of the second outer surface 14b, the third short sides of the fifth outer surface 14e, and the fourth short sides of the sixth outer surface 14f may each have the first dimension (corresponding to the thickness of the housing 14) set to a range of about 20 to 40 millimeters (mm). For example, the first long sides of the first outer surface 14a, the second long sides of the second outer surface 14b, the second sides of the third outer surface 14c, and the fourth sides of the fourth outer surface 14d may each have the second dimension (corresponding to the width of the housing 14) set to a range of about 80 to 120 mm. For example, the first sides of the third outer surface 14c, the third sides of the fourth outer surface 14d, the third long sides of the fifth outer surface 14e, and the fourth long sides of the sixth outer surface 14f may each have the third dimension (corresponding to the height of the housing 14) set to a range of about 120 to 250 mm. The first dimension, the second dimension, and the third dimension may be set to values different from the ranges of the above numerical values that satisfy “the first dimension<the second dimension<the third dimension”.

For example, the housing 14 may not have an external shape that is precisely a rectangular prism, and may have an external shape of a substantially thin rectangular prism. The housing 14 includes, for example, portions (also referred to as vertex portions) of eight vertexes each formed by three outer surfaces among the first outer surface 14a, the second outer surface 14b, the third outer surface 14c, the fourth outer surface 14d, the fifth outer surface 14e, and the sixth outer surface 14f. The housing 14 includes, for example, portions (also referred to as side portions) of twelve sides each formed by two outer surfaces among the first outer surface 14a, the second outer surface 14b, the third outer surface 14c, the fourth outer surface 14d, the fifth outer surface 14e, and the sixth outer surface 14f. One or more of the eight vertex portions may each be a rounded surface or a beveled inclined surface. For the vertex portions, for example, the beveled inclined surface may form an obtuse angle with each of the three outer surfaces surrounding the corresponding vertex portion and be inclined with respect to each of the three outer surfaces. One or more of the twelve side portions may each be a rounded surface or a beveled inclined surface. For the side portions, for example, the beveled inclined surface may form an obtuse angle with each of the two outer surfaces sandwiching the corresponding side portion and be inclined with respect to each of the two outer surfaces. For example, the first dimension may be the distance between the third outer surface 14c and the fourth outer surface 14d, the second dimension may be the distance between the fifth outer surface 14e and the sixth outer surface 14f, and the third dimension may be the distance between the first outer surface 14a and the second outer surface 14b.

The housing 14 includes, in other words, a first wall 141, a second wall 142, a third wall 143, a fourth wall 144, a fifth wall 145, and a sixth wall 146.

The first wall 141 includes the first outer surface 14a of the housing 14. In other words, the first wall 141 defines the first outer surface 14a of the housing 14. In the example in FIGS. 1 to 8, the first wall 141 defines a portion of the housing 14 in the negative Z-direction. The first wall 141 may be, for example, a flat plate along an imaginary plane parallel to the XY plane. The first wall 141 is not limited to a flat plate, and may include, for example, one or more protrusions and recesses.

The second wall 142 includes the second outer surface 14b of the housing 14. In other words, the second wall 142 defines the second outer surface 14b of the housing 14. In the example in FIGS. 1 to 8, the second wall 142 defines a portion of the housing 14 in the positive Z-direction. The second wall 142 may be, for example, a flat plate along an imaginary plane parallel to the XY plane. The second wall 142 is not limited to a flat plate, and may include, for example, one or more protrusions and recesses.

The third wall 143 includes the third outer surface 14c of the housing 14. In other words, the third wall 143 defines the third outer surface 14c of the housing 14. In the example in FIGS. 1 to 8, the third wall 143 defines a portion of the housing 14 in the negative X-direction. The third wall 143 may be, for example, a flat plate along an imaginary plane parallel to the YZ plane. The third wall 143 is not limited to a flat plate, and may include, for example, one or more protrusions and recesses.

The fourth wall 144 includes the fourth outer surface 14d of the housing 14. In other words, the fourth wall 144 defines the fourth outer surface 14d of the housing 14. In the example in FIGS. 1 to 8, the fourth wall 144 defines a portion of the housing 14 in the positive X-direction. The fourth wall 144 may be, for example, a flat plate along an imaginary plane parallel to the YZ plane. The fourth wall 144 is not limited to a flat plate, and may include, for example, one or more protrusions and recesses.

The fifth wall 145 includes the fifth outer surface 14e of the housing 14. In other words, the fifth wall 145 defines the fifth outer surface 14e of the housing 14. In the example in FIGS. 1 to 8, the fifth wall 145 defines a portion of the housing 14 in the negative Y-direction. The fifth wall 145 may be, for example, a flat plate along an imaginary plane parallel to the XZ plane. The fifth wall 145 is not limited to a flat plate, and may include, for example, one or more protrusions and recesses.

The sixth wall 146 includes the sixth outer surface 14f of the housing 14. In other words, the sixth wall 146 defines the sixth outer surface 14f of the housing 14. In the example in FIGS. 1 to 8, the sixth wall 146 defines a portion of the housing 14 in the positive Y-direction. The sixth wall 146 may be, for example, a flat plate along an imaginary plane parallel to the XZ plane. The sixth wall 146 is not limited to a flat plate, and may include, for example, one or more protrusions and recesses.

The housing 14 includes, for example, an internal space 14i surrounded by the first wall 141, the second wall 142, the third wall 143, the fourth wall 144, the fifth wall 145, and the sixth wall 146. In other words, the first wall 141 is located in the negative Z-direction from the internal space 14i. The second wall 142 is located in the positive Z-direction from the internal space 14i. The third wall 143 is located in the negative X-direction from the internal space 14i. The fourth wall 144 is located in the positive X-direction from the internal space 14i. The fifth wall 145 is located in the negative Y-direction from the internal space 14i. The sixth wall 146 is located in the positive Y-direction from the internal space 14i.

The housing 14 includes a first opening 140a, a second opening 140b, and a third opening 140c.

The first opening 140a is open at least in the first outer surface 14a. The first opening 140a is an opening (also referred to as a light-emission opening) to allow light from the light source 11 to pass through. In the first embodiment, the first opening 140a extends through the first wall 141 in a thickness direction of the first wall 141.

In the example in FIGS. 1 to 8, the first opening 140a is elongated in the positive Y-direction. The first opening 140a is an elongated rectangle having a longitudinal direction that is the positive Y-direction when viewed in plan in the positive Z-direction. More specifically, the first opening 140a is open in an area from an end of the fifth outer surface 14e in the negative Z-direction through the first outer surface 14a to an end of the sixth outer surface 14f in the negative Z-direction. In other words, the first opening 140a extends through the first wall 141 in the negative Z-direction. More specifically, the first opening 140a extends through the housing 14 in an area from an end of the fifth wall 145 in the negative Z-direction through the first wall 141 to an end of the sixth wall 146 in the negative Z-direction.

The first opening 140a may have, in a thickness direction of the housing 14, a dimension of, for example, about 20 to 70% of the first dimension corresponding to the thickness of the housing 14. For the housing 14 with the first dimension of about 30 mm, for example, the first opening 140a may have a dimension of about 8 mm in the thickness direction of the housing 14. In the example in FIGS. 1 to 8, the thickness direction of the housing 14 is the positive X-direction as the second direction. The first opening 140a may have, in a width direction of the housing 14, a dimension that is, for example, substantially the same as the second dimension corresponding to the width of the housing 14. For the housing 14 with the second dimension of about 120 mm, for example, the first opening 140a may have a dimension of about 120 mm in the width direction of the housing 14. In the example in FIGS. 1 to 8, the width direction of the housing 14 is the positive Y-direction. With the first opening 140a extending across the entire first outer surface 14a in the width direction of the housing 14, the light irradiator 1 can be smaller. In this case, for example, the amount of light emitted from multiple light irradiators 1 aligned in the width direction of the light irradiators 1 may be uniformly distributed in the width direction of the light irradiators 1. The first opening 140a may not have, in the width direction of the housing 14, a dimension that is substantially the same as the second dimension corresponding to the width of the housing 14. The first opening 140a may have, but is not limited to, an elongated rectangular shape similarly to the first outer surface 14a. For example, the first opening 140a may have a shape determined as appropriate for, for example, the shape of an area to be irradiated with light from the light irradiator 1 in the target (irradiation target). The first opening 140a may have, for example, a wavy shape elongated in the width direction of the housing 14, an oval shape elongated in the width direction of the housing 14, or a shape including multiple circular portions aligned in the width direction of the housing 14. The first opening 140a may have dimensions determined within the dimensions of the first outer surface 14a as appropriate for, for example, the dimensions of the area to be irradiated with light from the light irradiator 1 in the target (irradiation target) when the first outer surface 14a is viewed in plan. The first opening 140a may be open in a center portion of the first outer surface 14a including the center point of the first outer surface 14a or at a position displaced from the center point of the first outer surface 14a on the first outer surface 14a.

The second opening 140b is open in an area of the third outer surface 14c adjacent to the first outer surface 14a. For example, the third outer surface 14c is hypothetically equally divided into N1 (N1 is a natural number greater than or equal to 2) areas in the positive Z-direction as the first direction. In this case, the area of the third outer surface 14c adjacent to the first outer surface 14a may be included in, for example, the area closest to the first outer surface 14a of the N1 areas. The natural number N1 may be set as appropriate for, for example, the design for intake and exhaust and heat dissipation in the light irradiator 1. The natural number N1 may be, for example, 2, 3, or 4.

The second opening 140b connects the internal space 14i of the housing 14 and a space (also referred to as an external space) 140 outside the housing 14. For example, the second opening 140b serves as an opening (also referred to as an inlet) to draw air from the external space 140 of the housing 14 into the internal space 14i. In the first embodiment, the second opening 140b extends through the third wall 143 in a thickness direction of the third wall 143. The housing 14 includes, for example, an end face (also referred to as a first end face) 143e that is an edge of the second opening 140b adjacent to the first outer surface 14a. More specifically, for example, the third wall 143 includes the first end face 143e that is the edge of the second opening 140b adjacent to the first outer surface 14a.

In the example in FIGS. 1 to 8, the second opening 140b is rectangular. More specifically, the second opening 140b is rectangular and includes a pair of long sides (also referred to as fifth long sides) each extending in the positive Y-direction and a pair of short sides (also referred to as fifth short sides) each extending in the positive Z-direction. In other words, the second opening 140b extends through the third wall 143 in the positive X-direction. The fifth long sides of the second opening 140b may have a dimension less than or equal to the dimension of the first long sides in the width direction of the housing 14. The fifth short sides of the second opening 140b may have a dimension determined as appropriate for, for example, the dimensions of the heat dissipator 12 and the design for intake and exhaust and heat dissipation in the light irradiator 1.

The third opening 140c is open in an area extending from the second outer surface 14b to a portion of the third outer surface 14c adjacent to the second outer surface 14b. For example, the third outer surface 14c is hypothetically equally divided into N2 (N2 is a natural number greater than or equal to 4) portions in the positive Z-direction as the first direction. In this case, the portion of the third outer surface 14c adjacent to the second outer surface 14b may be included in, for example, the portion closest to the second outer surface 14b of the N2 portions. The natural number N2 may be set as appropriate for, for example, the design for intake and exhaust and heat dissipation in the light irradiator 1. The natural number N2 may be, for example, 4, 5, 6, 7, 8, 9, or 10.

The third opening 140c connects the internal space 14i of the housing 14 and the external space 140 of the housing 14. The third opening 140c serves as, for example, an opening (also referred to as an outlet) to discharge air from the internal space 14i of the housing 14 to the external space 140.

The third opening 140c may include multiple holes that are each open in the area extending from the second outer surface 14b to the portion of the third outer surface 14c adjacent to the second outer surface 14b. In the example in FIGS. 1 to 8, the multiple holes are multiple slit-like holes (also referred to as slits) SL1. Each of the slits SL1 is open in the area extending from the second outer surface 14b to the portion of the third outer surface 14c adjacent to the second outer surface 14b. In other words, each of the slits SL1 extends through the second wall 142 and the third wall 143 in a portion from the second wall 142 to the third wall 143. In other words, the portion from the second wall 142 to the third wall 143 includes the multiple slits SL1 for discharging air from the internal space 14i of the housing 14 to the external space 140. In this case, the multiple slits SL1 serve as outlets.

The multiple slits SL1 are a first predetermined number of slits SL1. The first predetermined number is greater than or equal to 2. In other words, the multiple slits SL1 are two or more slits SL1. For example, the multiple slits SL1 may be aligned in the width direction of the housing 14 from the fifth outer surface 14e to the sixth outer surface 14f. For example, the multiple slits SL1 may be aligned at a first pitch in the width direction of the housing 14. Each of the slits SL1 includes a first elongated portion and a second elongated portion connected in an L-shape. The first elongated portion is open in the second outer surface 14b and extends in the thickness direction of the housing 14 from the fourth outer surface 14d to the third outer surface 14c. The second elongated portion is open in the third outer surface 14c and extends in a height direction of the housing 14 from the second outer surface 14b to the first outer surface 14a. The third opening 140c including, for example, the multiple slits SL1 as described above may reduce entry of foreign matter into the internal space 14i from the external space 140 of the housing 14. Examples of the foreign matter may include dust, dirt, a metal component, and a tool. The multiple holes in the third opening 140c may be arranged in, for example, a mesh pattern.

In the example in FIGS. 2, 4, and 6 to 8, the first predetermined number of slits SL1 are aligned in the positive Y-direction that is the width direction of the housing 14. Each of the slits SL1 includes the first elongated portion and the second elongated portion connected in an L-shape. The first elongated portion is open in the second outer surface 14b and extends in the negative X-direction. The second elongated portion is open in the third outer surface 14c and extends in the negative Z-direction. The first predetermined number and the first pitch for the multiple slits SL1 and the width and the length of each of the slits SL1 may be set as appropriate for, for example, the design for intake and exhaust and heat dissipation in the light irradiator 1 and the design of the appearance of the light irradiator 1.

The first predetermined number may be, for example, about 28. In other words, the multiple slits SL1 may be about twenty-eight slits SL1. The first pitch may be, for example, about 4 mm. Each of the multiple slits SL1 may have a width of about 2 mm. The first elongated portion of each of the slits SL1 may have a dimension (also referred to as a fourth dimension) of, for example, about 5 mm in the negative X-direction. The second elongated portion of each of the slits SL1 may have a dimension (also referred to as a fifth dimension) of, for example, about 15 mm in the negative Z-direction. The first predetermined number is not limited to 28, and may be any other number about, for example, 20 to 40. In other words, the multiple slits SL1 may be any other number of slits SL1 than 28 such as about 20 to 40. The first pitch is not limited to about 4 mm, and may have a dimension set to about 2 to 6 mm based on, for example, the first predetermined number. The dimension (fourth dimension) of the first elongated portion of each of the slits SL1 in the negative X-direction is not limited to about 5 mm, and may be set to about 3 to 10 mm based on, for example, the thickness of the housing 14 and the positions of the connectors 17. The dimension (fifth dimension) of the second elongated portion of each of the slits SL1 in the negative Z-direction is not limited to about 15 mm, and may be set to about 10 to 20 mm based on, for example, the size of the housing 14. The width, the dimension (fourth dimension) of the first elongated portion, and the dimension (fifth dimension) of the second elongated portion of each of the slits SL1 may be the same or different between the multiple slits SL1.

The arrangement, the shapes, and the sizes of the second opening 140b and the third opening 140c in the housing 14 may be determined as appropriate for, for example, the design for intake and exhaust and heat dissipation in the light irradiator 1.

The material for the housing 14 may be, for example, a metal such as aluminum or plastic.

For example, multiple members may be joined to one another to form the housing 14. For example, the multiple members may be fixed to the heat dissipator 12 to be joined together with the heat dissipator 12 or may be directly joined together. The multiple members included in the housing 14 may include, for example, a first member, a second member, and a third member. The first member may include, for example, the first wall 141 and portions of the third wall 143, the fourth wall 144, the fifth wall 145, and the sixth wall 146 closer to the first wall 141 than the heat dissipator 12. The second member may include, for example, portions of the fourth wall 144, the fifth wall 145, and the sixth wall 146 each extending from an area along the heat dissipator 12 to an area along the second wall 142. The third member may include, for example, the second wall 142 and a portion of the third wall 143 extending from an area along the heat dissipator 12 to an area along the second wall 142.

The multiple members may be fixed to the heat dissipator 12 by fastening with, for example, screws. The multiple members may not be fixed to the heat dissipator 12 by fastening with, for example, screws, and may be fixed to the heat dissipator 12 in other manners such as by bonding, joining, crimping, and fitting. The multiple members may be directly joined together in various manners such as by fastening with, for example, screws, bonding, joining, crimping, and fitting.

Each of the first member, the second member, and the third member may include, for example, portions (also referred to as joints) to be joined to one another. For example, the third member may include a plate-like first joint extending from the first side of the third wall 143 adjacent to the fifth wall 145 and along a part of the fifth wall 145, and a plate-like second joint extending from the first side of the third wall 143 adjacent to the sixth wall 146 and along a part of the sixth wall 146. In this case, for example, the second member and the third member may be joined together by fastening the first joint and the fifth wall 145 with, for example, screws and fastening the second joint and the sixth wall 146 with, for example, screws. The first member may be manufactured by, for example, metal casting or resin molding. Each of the second member and the third member may be manufactured, for example, by various types of processing on a metal plate or by resin molding. The various types of processing may include, for example, one or more of stamping, bending, punching, and cutting.

### Heat Dissipator 12

The heat dissipator 12 dissipates heat generated in response to light emission from the light source 11. The heat dissipator 12 is thermally connected to the light source 11. The material for the heat dissipator 12 is, for example, a metal with high thermal conductivity such as aluminum or copper. The heat dissipator 12 thermally connected to the light source 11 may include, in addition to the heat dissipator 12 directly connected to the light source 11, the heat dissipator 12 indirectly connected to the light source 11 with, for example, one or more members with high thermal conductivity.

The heat dissipator 12 includes a base 121 and multiple protrusions 122.

The base 121 is in the internal space 14i of the housing 14 and adjacent to the first outer surface 14a. For example, the internal space 14i is hypothetically equally divided into N3 (N3 is a natural number greater than or equal to 4) areas in the positive Z-direction as the first direction. In this case, the area adjacent to the first outer surface 14a in the internal space 14i of housing 14 may be included in, for example, the area closest to the first outer surface 14a of the N3 areas. The natural number N3 may be set as appropriate for, for example, the design for intake and exhaust and heat dissipation in the light irradiator 1. The natural number N3 may be, for example, 4, 5, or 6. The base 121 may be, for example, a block or a plate.

For example, the base 121 may be in contact with the inner surface of the housing 14. In this case, for example, the third wall 143 may be fixed to the base 121, the fourth wall 144 may be fixed to the base 121, the fifth wall 145 may be fixed to the base 121, or the sixth wall 146 may be fixed to the base 121. The third wall 143 includes, for example, a surface (also referred to as a first inner surface) Iw1 facing the internal space 14i. The fourth wall 144 includes, for example, a surface (also referred to as a second inner surface) Iw2 facing the internal space 14i. For example, the base 121 may be in contact with the first inner surface Iw1 of the third wall 143 or the second inner surface Iw2 of the fourth wall 144. In other words, for example, the base 121 may be in contact with the first inner surface Iw1 that is a portion of the inner surface of the housing 14 adjacent to the third outer surface 14c in the internal space 14i or the second inner surface Iw2 that is a portion of the inner surface of the housing 14 adjacent to the fourth outer surface 14d in the internal space 14i. The fifth wall 145 includes, for example, a surface (also referred to as a third inner surface) facing the internal space 14i. The sixth wall 146 includes, for example, a surface (also referred to as a fourth inner surface) facing the internal space 14i. For example, the base 121 may be in contact with the third inner surface of the fifth wall 145 or the fourth inner surface of the sixth wall 146. In other words, for example, the base 121 may be in contact with the third inner surface that is a portion of the inner surface of the housing 14 adjacent to the fifth outer surface 14e in the internal space 14i or the fourth inner surface that is a portion of the inner surface of the housing 14 adjacent to the sixth outer surface 14f in the internal space 14i.

For example, the base 121 may be adjacent to the inner surface of the housing 14. In this case, the base 121 and the inner surface of the housing 14 may be in close contact with each other with, for example, thermal grease, which is also referred to as thermally conductive grease or heat sink grease. For example, the base 121 may be adjacent to the first inner surface Iw1 of the third wall 143 or the second inner surface Iw2 of the fourth wall 144. For example, the base 121 may be adjacent to the third inner surface of the fifth wall 145 or the fourth inner surface of the sixth wall 146.

In the example in FIGS. 8 to 10, the base 121 is a rectangular prism including outer surfaces each along an imaginary plane parallel to the first outer surface 14a and the second outer surface 14b. More specifically, the base 121 may be a rectangular prism along an imaginary plane parallel to the XY plane. The base 121 may include a surface (also referred to as a first surface) 121u adjacent to and facing the second outer surface 14b. The first surface 121u may face in, for example, the positive Z-direction. In other words, the first surface 121u may extend along an imaginary plane parallel to the XY plane. For example, the first surface 121u may be flush with the first end face 143e that is the edge of the second opening 140b in the housing 14 adjacent to the first outer surface 14a or may be slightly displaced from the first end face 143e toward the first outer surface 14a or the second outer surface 14b. In other words, the base 121 may be mostly or entirely located closer to the first outer surface 14a than to the second opening 140b. The base 121 includes a surface (also referred to as a second surface) 121b adjacent to the first outer surface 14a. The second surface 121b may face in, for example, the negative Z-direction. In other words, the second surface 121b may extend along an imaginary plane parallel to the XY plane.

Each of the multiple protrusions 122 protrudes from the base 121 toward the second outer surface 14b in the first direction from the first outer surface 14a to the second outer surface 14b. Multiple clearances 12s are between the multiple protrusions 122. The multiple clearances 12s between the multiple protrusions 122 are adjacent to the second opening 140b. In other words, the multiple clearances 12s connect with the external space 140 through the second opening 140b. This allows air to flow into the multiple clearances 12s from the external space 140 of the housing 14 through the second opening 140b.

Each of the multiple protrusions 122 may be, for example, a thin plate. The heat dissipator 12 allows air to flow through the multiple clearances 12s between the multiple protrusions 122 to dissipate heat transferred from the light source 11 to the heat dissipator 12 into the air. This may cool the light source 11. The multiple protrusions 122 are a second predetermined number of protrusions 122. The second predetermined number is greater than or equal to 2. In other words, the multiple protrusions 122 are two or more protrusions 122. For example, the multiple protrusions 122 may be aligned in the width direction of the housing 14 from the fifth outer surface 14e to the sixth outer surface 14f. For example, the multiple protrusions 122 may be aligned at a second pitch in the width direction of the housing 14. Each of the multiple protrusions 122 may be, for example, a thin plate (also referred to as a fin) along an imaginary plane parallel to the fifth outer surface 14e. Each of the multiple protrusions 122 may have a thickness in the width direction of the housing 14 from the fifth outer surface 14e to the sixth outer surface 14f. Each of the multiple protrusions 122 may have a predetermined dimension (also referred to as a sixth dimension) in, for example, the first direction from the first outer surface 14a to the second outer surface 14b.

In the example in FIGS. 2 and 6 to 10, each of the second predetermined number of protrusions 122 protrudes from the first surface 121u of the base 121 in the positive Z-direction as the first direction. Each of the second predetermined number of protrusions 122 is a thin plate (fin) along an imaginary plane parallel to the XZ plane and has a thickness in the positive Y-direction as the width direction of the housing 14. Each of the second predetermined number of protrusions 122 has the predetermined dimension (sixth dimension) in the positive Z-direction as the first direction. The multiple protrusions 122 are aligned at the second pitch in the positive Y-direction as the width direction of the housing 14. The second predetermined number and the second pitch for the multiple protrusions 122 and the thickness and the sixth dimension of each of the protrusions 122 may be set as appropriate for, for example, the design for intake and exhaust and heat dissipation in the light irradiator 1.

The second predetermined number may be, for example, about 19. In other words, the multiple protrusions 122 may be nineteen protrusions 122. The second pitch may be, for example, about 6 mm. Each of the multiple protrusions 122 may have a thickness of, for example, about 2 mm. Each of the multiple protrusions 122 may have the sixth dimension of, for example, about 28 mm. The second predetermined number is not limited to 19, and may be any other number about, for example, 10 to 30. In other words, the multiple protrusions 122 may be any other number of protrusions 122 than 19, such as about 10 to 30. The second pitch is not limited to 6 mm, and may have a dimension of about 4 to 11 mm based on, for example, the second predetermined number. Each of the protrusion 122 may not have a thickness of 2 mm, and may have a thickness of, for example, about 1 to 4 mm. The sixth dimension of the protrusions 122 is not limited to 28 mm, and may be, for example, about 20 to 40 mm. The width and the sixth dimension of each of the protrusions 122 may be the same or different between the multiple protrusions 122.

Two adjacent protrusions 122 of the multiple protrusions 122 are arranged across a clearance 12s. For example, all the multiple clearances 12s connecting with the external space 140 through the second opening 140b can increase the amount of air flowing from the external space 140 into the multiple clearances 12s through the second opening 140b per unit time. In the example in FIGS. 2 and 6 to 10, when the multiple protrusions 122 are nineteen fins, eighteen clearances 12s are between the nineteen fins. For example, all the eighteen clearances 12s as the multiple clearances 12s connecting with the external space 140 through the second opening 140b can increase the amount of air flowing from the external space 140 into the multiple clearances 12s through the second opening 140b per unit time.

For example, the heat dissipator 12 may be a rectangular metal block with many channels formed by, for example, cutting the metal block to increase its surface area or may be a metal block or a metal flat plate with multiple metal sheets attached.

### Light Source 11

The light source 11 is located on the surface of the base 121 in the heat dissipator 12 adjacent to the first outer surface 14a. The light source 11 faces the first opening 140a that is open in the first outer surface 14a. The light source 11 includes, for example, substrates 111 and the multiple light emitters 112. In the example in FIG. 5, the light source 11 includes three substrates 111 and eighteen light emitters 112. The multiple light emitters 112 are arranged on the substrates 111.

The substrates 111 are substrates (also referred to as light emitter substrates) on which the multiple light emitters 112 are arranged. The substrates 111 are, for example, plate-like ceramic substrates (also referred to as ceramic wiring boards). Wiring conductors electrically connecting the inside and the outside of the substrates 111 are located on the surfaces of the substrates 111 and inside the substrates 111. The material for the wiring conductors is a conductive material such as tungsten, molybdenum, manganese, or copper. For the substrates 111 that are ceramic wiring boards, the base material for the ceramic wiring boards is an insulating ceramic material. The ceramic wiring boards are thus resistant to heat generated by the light source 11 integrating the multiple light emitters 112.

The substrates 111 are located on the surface of the base 121 in the heat dissipator 12 adjacent to the first outer surface 14a. The substrates 111 are, for example, plates along the base 121. The substrates 111 may be, for example, fixed to the base 121. The substrates 111 may be fixed to the base 121 by, for example, screwing. The base 121 and the substrates 111 may be in close contact with each other with thermal grease between the base 121 and the substrates 111. This may improve thermal connection between the light source 11 and the heat dissipator 12. This may increase the efficiency of heat dissipation from the light source 11 through the heat dissipator 12. The substrates 111 may each be fixed to the base 121 with, for example, a metal member with high thermal conductivity.

Each of the multiple light emitters 112 is, for example, a light-emitting diode (LED) element. The light emitter 112 may be of any type selected as appropriate for the wavelength of light emitted from the light emitter 112. For example, the LED element may be a gallium nitride (GaN) LED that emits ultraviolet light or a gallium arsenide (GaAs) LED that emits infrared light. For example, the multiple light emitters 112 may be aligned in a row or in a matrix of multiple rows on the substrates 111.

In the example in FIG. 5, the substrates 111 are flat plates along an imaginary plane parallel to the XY plane. The substrates 111 are fixed on the second surface 121b of the base 121. The three substrates 111 are aligned adjacent to each other in the positive Y-direction. The eighteen light emitters 112 are aligned in a row in the positive Y-direction on the three substrates 111. More specifically, six light emitters 112 are aligned in a row in the positive Y-direction on a surface of each of the three substrates 111 facing in the negative Z-direction.

### Drive 13

The drive 13 is located between the multiple protrusions 122 and the second outer surface 14b in the internal space 14i of the housing 14.

The drive 13 is electrically connected to the light source 11. The drive 13 includes, for example, a wiring board 131 and a drive circuit 132.

The wiring board 131 is, for example, a printed circuit board. The wiring board 131 is fixed to, for example, the inner surface of the housing 14. For example, the wiring board 131 may be fixed to the inner surface of the housing 14 by, for example, screwing with, for example, a stand, a support rod, or a spacer placed on the inner surface of the housing 14 between the wiring board 131 and the inner surface of the housing 14. For example, the wiring board 131 may be fitted into a recess on the inner surface of the housing 14 to be fixed to the inner surface of the housing 14. In the example in FIG. 8, the wiring board 131 is fixed to the inner surface of the second wall 142 of the housing 14. The wiring board 131 may be, for example, a flat plate located along an imaginary plane parallel to the YZ plane.

The drive circuit 132 includes, for example, one or more electronic components 132i. In FIG. 8, the area with one or more electronic components 132i is indicated by the elongated rectangle hatched with diagonal lines from the lower left to the upper right. One or more electronic components 132i are attached to the wiring board 131. For example, the drive circuit 132 can supply power to the light source 11 and also control light emission of the light source 11. The drive 13 including the drive circuit 132 generates heat in driving the light source 11. The drive 13 is thus to be cooled through appropriate heat dissipation. When one or more electronic components 132i include multiple electronic components 132i that are not arranged densely, the drive circuit 132 may have a smaller temperature increase.

When, for example, one or more electronic components 132i include an electronic component such as a power transistor that tends to generate more heat, a heat sink may be attached to the drive 13 to increase heat dissipation from the electronic components 132i. To allow air to effectively flow to parts of the drive 13 that easily reach high temperatures, the housing 14 may include at least one selected from, for example, grooves, fins, or an air deflector on a portion of the inner surface of the housing 14 around the drive 13.

The drive circuit 132 and the light source 11 may be electrically connected to each other with various wiring members. More specifically, the drive circuit 132 and the multiple light emitters 112 may be electrically connected to each other with, for example, the various wiring members and the substrates 111. The various wiring members may be, for example, flexible printed circuits (FPCs). The FPCs may be connected to the drive circuit 132 with, for example, board-to-FPC connectors. The various wiring members electrically connecting the drive circuit 132 and the light source 11 may be at any location and have any shape and size determined as appropriate for the design for appropriate airflow through the internal space 14i of the housing 14. For example, the various wiring members may be arranged between the heat dissipator 12 and the second wall 142 to minimize their portions extending through a space between the drive 13 and the third wall 143. This can reduce a decrease in the flow velocity and the flow rate of air flowing from the multiple clearances 12s in the heat dissipator 12 toward the third opening 140c. This can reduce a decrease in the heat dissipation efficiency from the heat dissipator 12. In this example, the various wiring members may extend from the substrates 111 through a portion between the heat dissipator 12 and the inner surface of the housing 14 and further extend through a portion slightly away from the heat dissipator 12 to be connected to the drive circuit 132.

### Optical System 16

The optical system 16 can adjust an optical path of light emitted from the light source 11. The optical system 16 is located, for example, between the light source 11 and the first opening 140a or in the first opening 140a. The optical system 16 may have any shape and size determined as appropriate for specifications such as the size and the shape of the area to be irradiated with light in the target (irradiation target) and the intensity of light applied to the target (irradiation target). The optical system 16 may be, for example, any type of lens. In the example in FIGS. 1, 5, 6, and 8, the optical system 16 is a cylindrical rod lens with a central axis extending in the positive Y-direction. The optical system 16 may be, for example, an optical member different from a rod lens, such as a cylindrical lens that is semicylindrical or a transparent flat plate member. The material for the optical system 16 is, for example, transparent glass or heat-resistant plastic. The optical system 16 may include, for example, a reflector that reflects light.

### Connector 17

The connectors 17 connect multiple wires connected to the drive 13 and multiple wires outside the housing 14. The connectors 17 are located on, for example, the second outer surface 14b of the light irradiator 1. The light irradiator 1 may include a single connector 17 or two or more connectors 17. In the example in FIGS. 1 to 8, the light irradiator 1 includes two connectors 17. The multiple wires include, for example, wires (also referred to as power lines) for supplying power from an external source to the drive 13 and wires (also referred to as signal lines) for receiving signals from an external device to the drive 13 and transmitting signals from the drive 13 to the external device. The drive 13 can, for example, receive power from the source external to the light irradiator 1 and transmit or receive control signals to or from the device external to the light irradiator 1 through the connectors 17.

### 1-1-1. Airflow in Housing

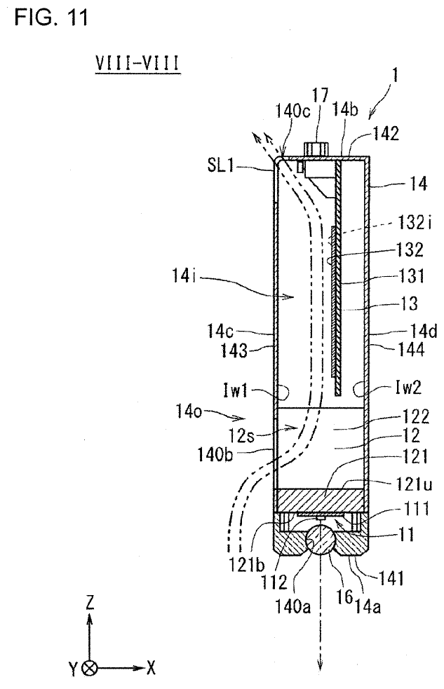

FIG. 11 is a schematic cross-sectional view of the light irradiator 1 according to the first embodiment, illustrating passages of air. The cross-sectional view in FIG. 11 corresponds to the cross-sectional view in FIG. 8. In FIG. 11, the light irradiator 1 is located with the first outer surface 14a facing downward, and the passages of air flowing in response to heat generated by the light source 11 emitting light are schematically illustrated by the two curves and arrows drawn with the two-dot-dash lines. In FIG. 11, light emitted from the light emitters 112 is schematically illustrated by the downward arrow drawn with the thin dot-dash line.

For example, with the first outer surface 14a facing downward, heat generated in response to the multiple light emitters 112 emitting light is dissipated into the internal space 14i of the housing 14 through the heat dissipator 12. In this case, air flowing from the external space 140 into the multiple clearances 12s between the multiple protrusions 122 through the second opening 140b is heated by the heat dissipated through the multiple protrusions 122 to ascend, and discharged to the external space 140 through the third opening 140c, creating a smooth airflow. Air flowing from the external space 140 passes through the second opening 140b, the internal space 14i, and the third opening 140c in this order and is discharged to the external space 140 by the stack effect. This airflow can cool the heat dissipator 12.

In the first embodiment, when the first outer surface 14a faces downward, the third opening 140c extends from the second outer surface 14b facing upward to an upper portion of the third outer surface 14c. Thus, when the connectors 17 are on the second outer surface 14b, the third opening 140c may be large enough to discharge air from the internal space 14i to the external space 140 and have a long distance to the multiple protrusions 122. This may produce smooth updraft from the multiple clearances 12s between the multiple protrusions 122 toward the third opening 140c and also increase the velocity of the updraft by the stack effect. The heat dissipator 12 can thus be cooled efficiently. The light irradiator 1 can thus cool the heat dissipator 12 efficiently without including a cooling fan. The light irradiator 1 can thus be smaller and have a simpler structure and fewer failures, as well as can have higher cooling performance.

For example, the drive 13 may be located in the internal space 14i and closer to the fourth outer surface 14d than to the third outer surface 14c. In other words, for example, the drive 13 may be located in the internal space 14i and closer to the fourth wall 144 than to the third wall 143. This may reduce a decrease in the flow velocity and the flow rate of air flowing from the multiple clearances 12s in the heat dissipator 12 toward the third opening 140c. For example, one or more electronic components 132i may be located between the second opening 140b and the third opening 140c in the first direction from the first outer surface 14a to the second outer surface 14b. For example, the drive 13 may be located with one or more electronic components 132i facing the third outer surface 14c. In other words, for example, the drive 13 may be located with one or more electronic components 132i facing the third wall 143. In other words, for example, the wiring board 131 may include a surface, on which one or more electronic components 132i are mounted, facing the third wall 143. In the example in FIGS. 8 and 11, the surface of the wiring board 131 on which one or more electronic components 132i are mounted may face in the negative X-direction.

With the first outer surface 14a facing downward in this structure, the passages of air ascending from the multiple clearances 12s toward the third opening 140c may include a passage along one or more electronic components 132i when heat generated in response to the multiple light emitters 112 emitting light is dissipated into the internal space 14i of the housing 14 through the heat dissipator 12. This may allow more air to flow to one or more electronic components 132i, thus cooling the drive circuit 132 more efficiently. This may improve the operational stability of the drive circuit 132 and the reliability of the light irradiator 1.

When, for example, the base 121 in the heat dissipator 12 is in contact with the inner surface of the housing 14, the heat dissipator 12 can be cooled more efficiently through heat transfer from the heat dissipator 12 to the housing 14.

For example, the multiple clearances 12s may include their portions adjacent to the base 121 that are located adjacent to the second opening 140b. The second opening 140b may have a dimension less than or equal to the dimension of the multiple protrusions 122 in the first direction from the first outer surface 14a to the second outer surface 14b. With the first outer surface 14a facing downward in this structure, air flowing from the external space 140 into the internal space 14i of the housing 14 through the second opening 140b may pass through wider areas in the multiple clearances 12s when heat generated in response to the multiple light emitters 112 emitting light is dissipated into the internal space 14i of the housing 14 through the heat dissipator 12. The second opening 140b and the third opening 140c may have a long distance between them. This may increase the velocity of the updraft from the multiple clearances 12s between the multiple protrusions 122 toward the third opening 140c produced by the stack effect. The heat dissipator 12 can thus be cooled efficiently. The size of the portions of the multiple clearances 12s adjacent to the base 121 may be determined as appropriate for, for example, the dimensions of the light irradiator 1 and the design for intake and exhaust and heat dissipation in the light irradiator 1. The portions of the multiple clearances 12s adjacent to the base 121 may include, for example, areas in contact with the first surface 121u of the base 121 in the multiple clearances 12s or areas adjacent to the first surface 121u of the base 121 in the multiple clearances 12s.

For example, the multiple protrusions 122 may include their portions adjacent to the second outer surface 14b in contact with the first inner surface Iw1 of the housing 14 adjacent to the third outer surface 14c in the internal space 14i. In this structure, the heat dissipator 12 can be cooled more efficiently through heat transfer from the multiple protrusions 122 to the housing 14. The size of the portions of the multiple protrusions 122 adjacent to the second outer surface 14b may be determined as appropriate for the dimensions of the light irradiator 1 and the design for, for example, intake and exhaust and heat dissipation in the light irradiator 1. For example, the multiple protrusions 122 are hypothetically equally divided into N4 (N4 is a natural number greater than or equal to 2) areas in the positive Z-direction as the first direction. In this case, the portions of the multiple protrusions 122 adjacent to the second outer surface 14b may each be included in, for example, the area closest to the second outer surface 14b of the N4 areas. The natural number N4 may be set as appropriate for the design for, for example, intake and exhaust and heat dissipation in the light irradiator 1. The natural number N4 may be, for example, 2, 3, 4, or any natural number greater than or equal to 5.

In this example, the second opening 140b has a dimension less than or equal to the dimension of the protrusions 122 in the first direction, and the portions of the multiple protrusions 122 adjacent to the second outer surface 14b are in contact with the first inner surface Iw1. In this case, multiple slit portions of the multiple clearances 12s in contact with the second opening 140b serve as substantial inlets to draw air from the external space 140 into the internal space 14i. For example, the total size of the multiple slits SL1 serving as outlets may be set to a range of about one to two times the size of the substantial inlets. In this case, a smooth airflow is efficiently produced for air flowing from the external space 140 and passing through the second opening 140b, the internal space 14i, and the third opening 140c in this order to be discharged to the external space 140.

For example, the second opening 140b may have a dimension of 12 mm in the first direction, the multiple protrusions 122 may be nineteen fins, the pitch (second pitch) between the multiple protrusions 122 may be 6 mm, and the multiple protrusions 122 may have a thickness of 2 mm. In this structure, the area of the substantial inlets (also referred to as an effective inlet area) is 864 mm² (=12 mm×4 mm×18). For example, the multiple slits SL1 in the third opening 140c may be twenty-eight L-shaped slits, and the pitch (first pitch) between the multiple slits SL1 may be 4 mm. For each of the slits SL1, the width may be 2 mm, the first elongated portion may have a dimension (fourth dimension) of 5 mm, and the second elongated portion may have a dimension (fifth dimension) of 15 mm. In this structure, the area of the outlets (also referred to as an outlet area) in the third opening 140c is 1120 mm² (=(5 mm+15 mm)×2 mm×28). In this case, the outlet area as the size of the multiple slits SL1 serving as outlets is larger than the effective inlet area that is the size of the substantial inlets and is about 1.3 times the effective inlet area.

### 1-1-2. Temperature Drift in Light Emitter

Light emitters such as LED elements being on emit light and generate heat. The temperature of the light emitters may change, thus causing the illuminance of light applied to the target (irradiation target) to vary. For example, a phenomenon (also referred to as a temperature drift) in which the luminance decreases in response to an increase in the temperature occurs in LED elements. The light emitters being on refers to the light emitters emitting light (also referred to as an emission state). In the present disclosure, the light emitters being on correspond to the light emitters emitting light.

In an experiment, the light irradiator 1 was fixed with a resin fixture with the first outer surface 14a facing upward, and the temperature of the multiple light emitters 112 and the illuminance of light from the light source 11 were measured with the light source 11 emitting light upward.

In the experiment, eighteen LED elements that emit light (also referred to as LED light) with a peak wavelength of 395 nanometers (nm) were used as the multiple light emitters 112. The eighteen LED elements were aligned in a row at an interval of 6.5 mm on the three substrates 111 aligned adjacent to each other in the width direction of the housing 14. To cause each of the LED elements to emit light, 0.35 amperes (A) of current was used to flow in a forward direction. The illuminance of light from the light source 11 was measured using an illuminometer (UVPF-A2 manufactured by Eye Graphics Company) fixed to the resin fixture. The temperature of the multiple light emitters 112 was measured by photographing the eighteen LED elements using a thermography camera (InfraRed Camera R500 manufactured by Nippon Avionics Co., Ltd.) fixed to the resin fixture and facing downward. The temperature of the room in which the experiment was conducted was 25 degrees as a reference temperature.

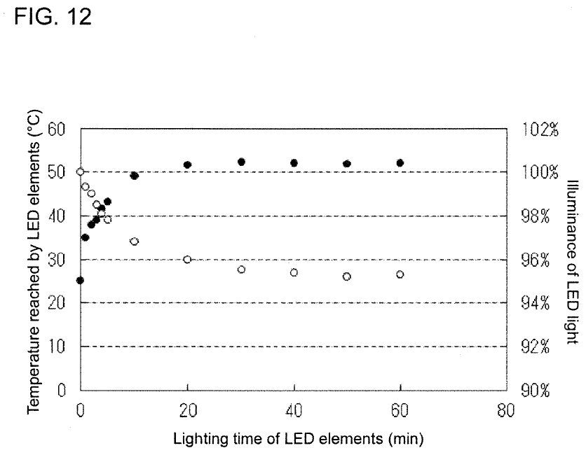

FIG. 12 is a graph showing example relationships between the lighting time of the LED elements, the temperature of the LED elements, and the illuminance of LED light emitted from the LED elements obtained in the experiment. The lighting time of the LED elements refers to the time for which the LED elements continue to emit light after the LED elements start emitting light. FIG. 12 shows the relationship between the lighting time of the LED elements and the temperature of the LED elements plotted with multiple solid circles and the relationship between the lighting time of the LED elements and the illuminance of LED light plotted with multiple outlined circles. FIG. 12 shows the percentage of the illuminance of LED light for an initial value, where the initial value is the illuminance at the time when the multiple LED elements are turned on.

As shown in FIG. 12, a temperature drift was observed, or specifically, the temperature of the LED elements increased over time after the multiple LED elements were turned on, and the illuminance of LED light decreased in response to an increase in the temperature of the LED elements.

The temperature drift can be approximately expressed by Formula 1 below, where D1 (percent or %) is the rate of decrease in the illuminance of LED light as the temperature drift, do (%/° C.) is the rate of decrease in the illuminance of LED light with respect to the temperature increase in the LED elements by 1 degree (° C.), T1 (° C.) is the temperature reached by the LED elements, and T0 (° C.) is the initial temperature of the LED elements.

$$D 1 ( \% ) = d 0 ( \% / ° C . ) \times ( T 1 ( ° C . ) - T 0 ( ° C . ) ) \qquad ( 1 )$$

For the temperature drift in the LED elements used in the above experiment, do (%) is approximately calculated to be 0.18 (%/° C.). The initial temperature T0 (° C.) of the LED elements was 25 (° C.) as the reference temperature described above. The temperature drift (%) in the LED elements used in the above experiment can be approximately expressed by Formula 2 below.

$$D 1 ( \% ) = 0.18 ( \% / ° C . ) \times ( T 1 ( ° C . ) - 25 ( ° C . ) ) \qquad ( 2 )$$

When the temperature of the multiple LED elements increases by a predetermined degree or less in the light irradiator 1, the light irradiator 1 may have a rate of decrease in the illuminance of light applied to the target (irradiation target) from the light irradiator 1 by a predetermined degree or less. This may stabilize the illuminance of light emitted from the light irradiator 1. The temperature drift D1(%) may be targeted to be, for example, less than or equal to 5%. In this case, the temperature drift D1(%) may be calculated, by Formula 2, to be less than or equal to 5% when the temperature T1 (° C.) reached by the LED elements is less than or equal to 53° C. In other words, to cause the temperature drift D1(%) to be less than or equal to 5% in the structure in the above experiment, the temperature reached by the LED elements is to be less than or equal to 53° C.

1-1-3. Relationship between Height of Second Opening and Temperature Reached by Light Emitters

In this example, the light irradiator 1 is used with the first outer surface 14a facing downward. In this case, a height H that is the dimension of the second opening 140b in the positive Z-direction as the first direction may be adjusted to reduce the temperature reached by the multiple light emitters 112 emitting light.

The simulation described below was performed for the relationship between the height H of the second opening 140b in the positive Z-direction as the first direction and the temperature reached by the multiple light emitters 112 in response to heat generated by the multiple light emitters 112 emitting light.

### Simulation Conditions

The simulation was performed using thermal fluid analysis software (SOLIDWORKS Flow Simulation) developed by KOZO KEIKAKU ENGINEERING Inc. In the simulation, the conditions below were used as the conditions of the light irradiator 1.

The light irradiator 1 was oriented with the first outer surface 14a facing downward.

For the housing 14, the first dimension that is the thickness of the housing 14 is 30 mm, the second dimension that is the width of the housing 14 is 120 mm, and the third dimension that is the height of the housing 14 is 134.8 mm. The housing 14 has rounded corners having a curvature radius of about 0.5 mm. The housing 14 includes the first member, the second member, and the third member each fixed to the heat dissipator 12 by screwing. The first member is a portion of the housing 14 closer to the first outer surface 14a than the heat dissipator 12. The first member has a dimension of 120 mm in the width direction of the housing 14, a dimension of 30 mm in the thickness direction of the housing 14, and a dimension of 14.8 mm in the height direction of the housing 14. The second member includes the portions of the fourth wall 144, the fifth wall 145, and the sixth wall 146 each extending from the area along the heat dissipator 12 to the area along the second wall 142. The third member includes the second wall 142 and the portion of the third wall 143 extending from the area along the heat dissipator 12 to the area along the second wall 142. Each of the second member and the third member is a bent plate having a thickness of 1 mm. The material for the housing 14 is aluminum with a thermal conductivity of 204 watts per meter per kelvin, or W/(m×K). The first opening 140a has a dimension of about 8.14 mm in the thickness direction of the housing 14 and a dimension of 120 mm, which is equal to the width of the housing 14, in the width direction of the housing 14 when the first outer surface 14a is viewed in plan. The first opening 140a includes a first circular portion and a first trapezoidal portion having an upper base continuous with a portion of the first circular portion adjacent to the first outer surface 14a when the fifth outer surface 14e is viewed in plan. The first circular portion has a diameter of 10.2 mm. The first trapezoidal portion has the upper base with a dimension of 8.14 mm and a lower base with a dimension of 13 mm. The first opening 140a includes a second circular portion and a second trapezoidal portion having an upper base continuous with a portion of the second circular portion adjacent to the first outer surface 14a when the sixth outer surface 14f is viewed in plan. The second circular portion has a diameter of 10.2 mm. The second trapezoidal portion has the upper base with a dimension of 8.14 mm and a lower base with a dimension of 13 mm. Each of the first circular portion and the second circular portion has a center point located at a distance of 10.3 mm from the heat dissipator 12 and in the middle of the housing 14 in the thickness direction.

The optical system 16 is a glass rod lens with a central axis of 120 mm extending in the width direction of the housing 14 and a diameter of 10 mm. The rod lens is fitted in both the first circular portion and the second circular portion of the first opening 140a.

The multiple light emitters 112 are eighteen LED elements aligned in a row at a pitch of 6.5 mm on the three substrates 111 aligned in the width direction of the housing 14. The eighteen LED elements generate 11 watts (W) of heat.

Each of the three substrates 111 has an external shape of a plate having a dimension of 39 mm in the width direction of the housing 14, a dimension of 15 mm in the thickness direction of the housing 14, and a dimension (also referred to as a thickness) of 2 mm in the height direction of the housing 14. The material for the three substrates 111 is copper with a thermal conductivity of 372 W/(m×K). The three substrates 111 are aligned adjacent to each other in the width direction of the housing 14.

The base 121 in the heat dissipator 12 is a rectangular prism having a dimension of 118 mm in the width direction of the housing 14, a dimension of 28 mm in the thickness direction of the housing 14, and a dimension (also referred to as a thickness) of 8 mm in the height direction of the housing 14. The multiple protrusions 122 in the heat dissipator 12 are nineteen fins arranged at a pitch of 6 mm in the width direction of the housing 14. Each of the fins is a thin plate having a dimension (also referred to as a thickness) of 2 mm in the width direction of the housing 14, a dimension of 28 mm in the thickness direction of the housing 14, and a dimension (also referred to as a height) of 28 mm in the height direction of the housing 14. The material for the heat dissipator 12 is aluminum with a thermal conductivity of 204 W/(m×K).

The drive 13 is a thin plate having a dimension of 80 mm in the width direction of the housing 14, a dimension (also referred to as a thickness) of 2 mm in the thickness direction of the housing 14, and a dimension of 100 mm in the height direction of the housing 14. The material for the wiring board 131 in the drive 13 is glass epoxy with a thermal conductivity of 0.38 W/(m×K). The drive 13 is located 9 mm away from the fourth wall 144 and parallel to the fourth wall 144.

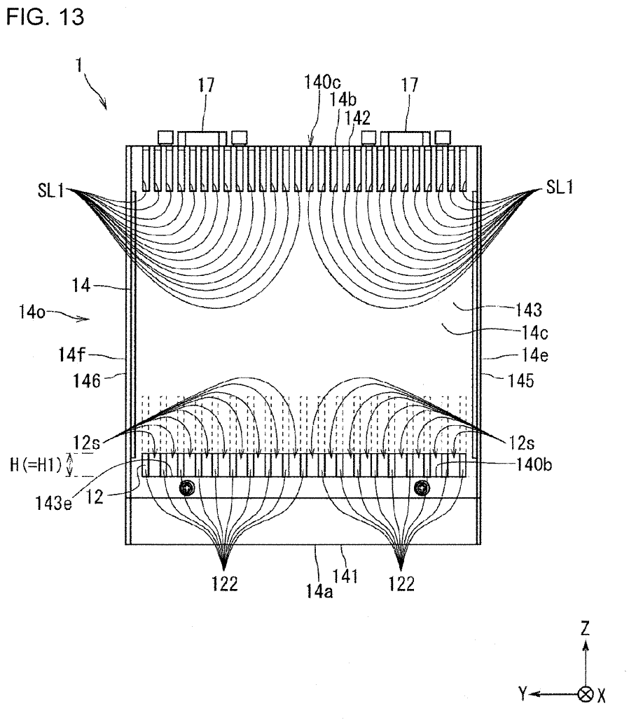

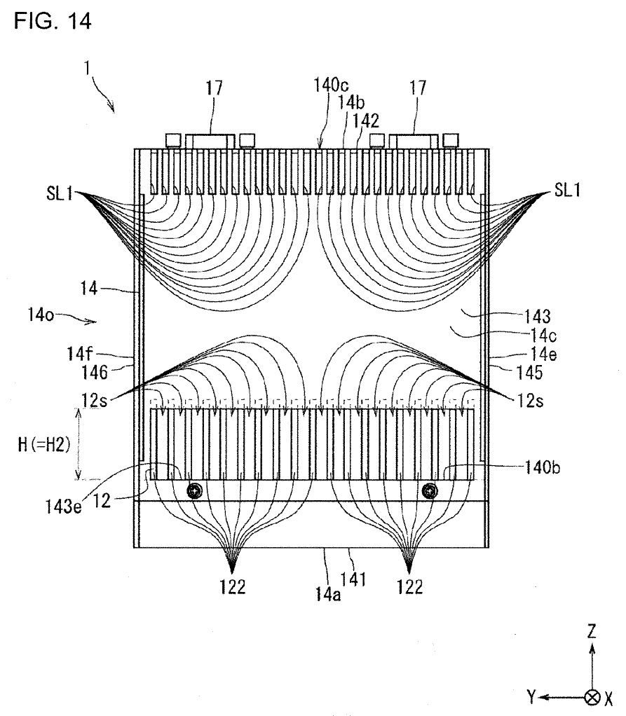

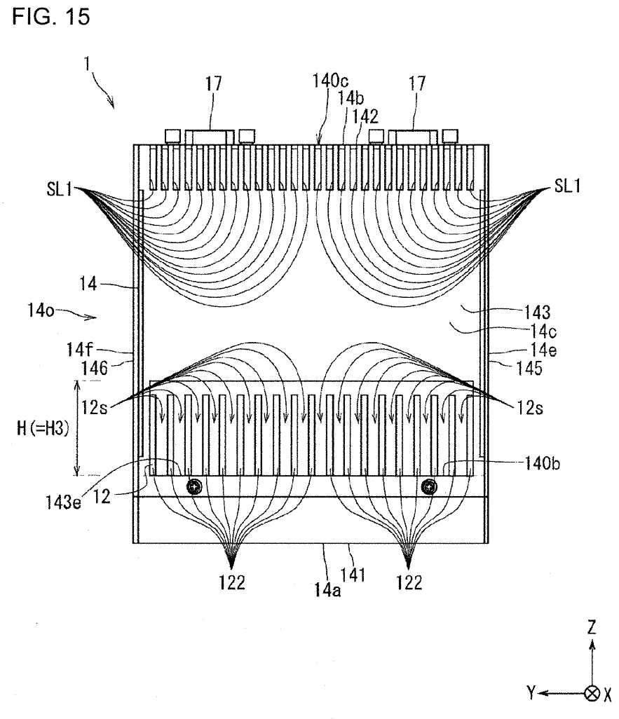

The second opening 140b is rectangular when viewed in plan. The first end face 143e that is the edge of the second opening 140b adjacent to the first outer surface 14a and the first surface 121u of the base 121 in the heat dissipator 12 adjacent to the second outer surface 14b are flush with each other. The second opening 140b has a dimension (also referred to as a width) of 110 mm in the width direction of the housing 14. The second opening 140b is varied to have nine different dimensions (heights) H of 0, 4, 8, 12, 16, 20, 24, 28, and 32 mm in the height direction of the housing 14. FIG. 13 is a left side view of an example light irradiator 1 with the second opening 140b having, in the positive Z-direction as the first direction, a first height H1 as the height H, illustrating its appearance. FIG. 14 is a left side view of an example light irradiator 1 with the second opening 140b having, in the positive Z-direction as the first direction, a second height H2 as the height H, illustrating its appearance. FIG. 15 is a left side view of an example light irradiator 1 with the second opening 140b having, in the positive Z-direction as the first direction, a third height H3 as the height H, illustrating its appearance. The second height H2 is greater than the first height H1, and the third height H3 is greater than the second height H2. The first height H1 in the example in FIG. 13 is 8 mm. The second height H2 in the example in FIG. 14 is 24 mm. The third height H3 in the example in FIG. 15 is 32 mm. In FIGS. 13 and 14, the outer edges of portions of the multiple protrusions 122 arranged on a rear surface of the third wall 143 are schematically illustrated by the thin dashed lines as hidden lines.

The third opening 140c includes twenty-eight slits SL1 at a pitch of 4 mm in the width direction of the housing 14. The slits SL1 are L-shaped and have the same shape and dimensions. Each of the slits SL1 is a rectangle with a dimension of 15 mm in the height direction of the housing 14 and a dimension of 2 mm in the width direction of the housing 14 when the third outer surface 14c is viewed in plan. Each of the slits SL1 is a rectangle with a dimension of 5 mm in the thickness direction of the housing 14 and a dimension of 2 mm in the width direction of the housing 14 when the second outer surface 14b is viewed in plan.

### Simulation Results

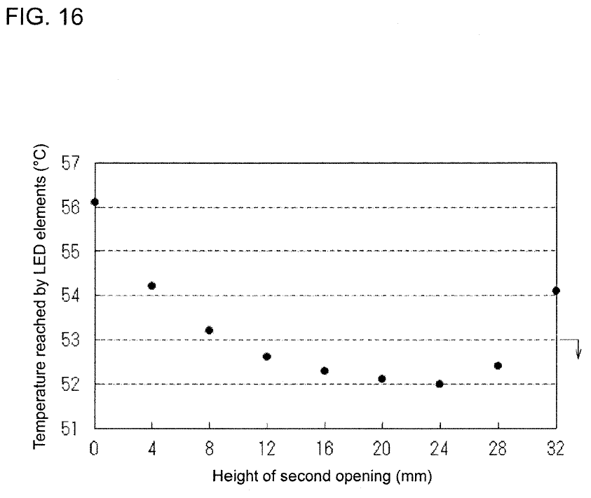

FIG. 16 is a graph showing example simulation results for the relationship between the height of the second opening 140b and the temperature reached by the LED elements being on. FIG. 16 shows the relationship between the height of the second opening 140b and the temperature reached by the LED elements plotted with multiple solid circles.

As shown in FIG. 16, the simulation results indicate that, when the second opening 140b has a height of 12 to 28 mm, the temperature reached by the LED elements is less than or equal to 53° C., at which the temperature drift D1 described above is less than or equal to 5%.

The results reveal that the temperature drift D1 can be less than or equal to 5% when, for example, the height of the second opening 140b is at least half and less than or equal to the dimension (height) of the protrusions 122 in the heat dissipator 12 in the height direction of the housing 14, or specifically, 28 mm. More specifically, the results reveal that the temperature drift D1 can be less than or equal to 5% when, for example, the height of the second opening 140b is greater than or equal to 43% (≈12/28×100(%)) of the dimension (height) of the protrusions 122 in the heat dissipator 12 in the height direction of the housing 14, or specifically, 28 mm, and less than or equal to the dimension (height) of the protrusions 122 in the heat dissipator 12 in the height direction of the housing 14, or specifically, 28 mm.

Thus, when, for example, the portions of the multiple clearances 12s adjacent to the base 121 are located adjacent to the second opening 140b and the dimension (height) H of the second opening 140b is, in the first direction from the first outer surface 14a to the second outer surface 14b, at least half the dimension of the multiple protrusions 122 and less than or equal to the dimension of the multiple protrusions 122, the light irradiator 1 can have higher cooling performance. More specifically, when the dimension (height) H of the second opening 140b is, in the first direction, greater than or equal to 43% of the dimension of the multiple protrusions 122 and less than or equal to the dimension of the multiple protrusions 122, the light irradiator 1 can have higher cooling performance. For example, the first surface 121u of the base 121 may be flush with the first end face 143e that is the edge of the second opening 140b in the housing 14 adjacent to the first outer surface 14a or may be slightly displaced from the first end face 143e toward the first outer surface 14a or the second outer surface 14b. Note that the dimension (height) H of the second opening 140b being at least half the dimension of the multiple protrusions 122 in the first direction may not include the dimension (height) H of the second opening 140b being precisely at least half the dimension of the multiple protrusions 122 in the first direction. In this example, being at least half the dimension of the multiple protrusions 122 may be being at least half with a dimensionally permissible tolerance. As shown in FIG. 16, when the dimension (height) H of the second opening 140b is about one-third of the dimension of the multiple protrusions 122 in the first direction, the temperature reached by the LED elements may not clearly be less than or equal to 53° C., and the light irradiator 1 may not clearly improve cooling performance. Thus, the dimension (height) H of the second opening 140b being at least half the dimension of the multiple protrusions 122 in the first direction includes being at least half the dimension with a certain tolerance. The dimension (height) H of the second opening 140b being at least half the dimension of the multiple protrusions 122 in the first direction may include, for example, the dimension (height) H of the second opening 140b being greater than or equal to 43% of the dimension of the multiple protrusions 122 in the first direction.

### 1-2. Schematic Structure of Printing Apparatus

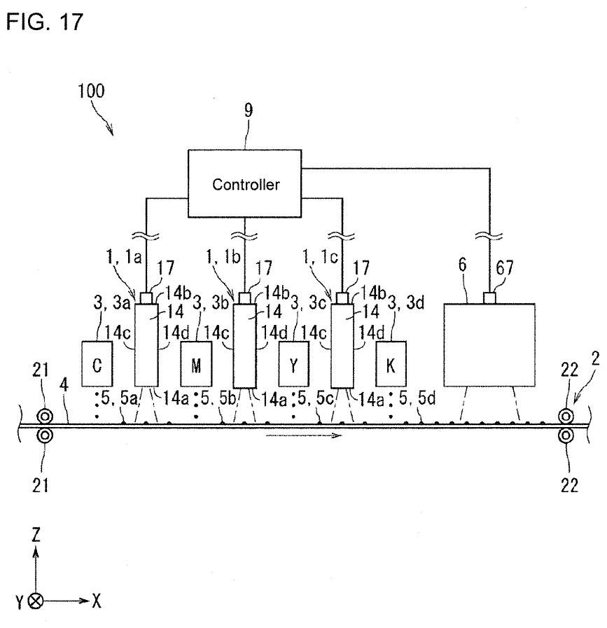

FIG. 17 is a schematic diagram of a printing apparatus 100 according to the first embodiment.

As illustrated in FIG. 17, the printing apparatus 100 includes the light irradiators (also referred to as first light irradiators) 1 described above, a feeder 2, and printing units 3. In the example in FIG. 17, the printing apparatus 100 includes three first light irradiators 1, the feeder 2, four printing units 3, another light irradiator (also referred to as a second light irradiator) 6, and a controller 9. The three first light irradiators 1 include a first-A light irradiator 1a, a first-B light irradiator 1b, and a first-C light irradiator 1c. The four printing units 3 include a first printing unit 3a, a second printing unit 3b, a third printing unit 3c, and a fourth printing unit 3d.

### Feeder 2

The feeder 2 can feed a print medium 4 in a predetermined direction (also referred to as a second direction or a feed direction). The print medium 4 is an object to be printed by the printing apparatus 100. The print medium 4 may be, for example, a paper sheet or a resin sheet, or a thin plate made of a resin, a semiconductor, metal, or wood.

In the example in FIG. 17, the feeder 2 can feed the print medium 4 placed along an imaginary plane parallel to a horizontal plane in the positive X-direction as the second direction. In other words, the feed direction is the positive X-direction. The width direction of the print medium 4 perpendicular to the feed direction is the positive Y-direction. The thickness direction of the print medium 4 is the positive Z-direction as the first direction. In FIG. 17, the feed direction is indicated by the arrow drawn with the thin solid lines.

In the example in FIG. 17, the first printing unit 3a, the first-A light irradiator 1a, the second printing unit 3b, the first-B light irradiator 1b, the third printing unit 3c, the first-C light irradiator 1c, the fourth printing unit 3d, and the second light irradiator 6 are arranged in this order in the positive X-direction as the feed direction above the print medium 4 being fed by the feeder 2.

As illustrated in FIG. 17, the feeder 2 may include, for example, a pair of feed rollers 21 upstream from the printing apparatus 100 and a pair of feeder rollers 22 downstream from the printing apparatus 100. The pair of feed rollers 21 sandwiches the print medium 4 from above and below to hold the print medium 4. The pair of feed rollers 22 sandwiches the print medium 4 from above and below to hold the print medium 4. The print medium 4 can be fed in the feed direction as the pair of upstream feed rollers 21 and the pair of downstream feed rollers 22 rotate. The pair of feed rollers 21 may each be driven by, for example, an electric motor to rotate. The pair of feed rollers 22 may each be driven by, for example, an electric motor to rotate.

The feeder 2 may include, for example, a support that supports the print medium 4 from below between the pair of upstream feed rollers 21 and the pair of downstream feed rollers 22. The support may include, for example, multiple cylindrical rollers (also referred to as support rollers). The multiple support rollers may each have an axial direction perpendicular to the feed direction and may be aligned in the feed direction.

### Printing Unit 3

The printing units 3 can print on the print medium 4. The printing units 3 are arranged farther than the respective first light irradiators 1 in a direction (also referred to as a third direction) opposite the feed direction (second direction). Being arranged in the third direction is, in other words, being arranged upstream in the feed direction. In other words, the printing units 3 are arranged upstream from the respective first light irradiators 1 in the feed direction of the print medium 4. In the example in FIG. 17, the third direction is the negative X-direction.

In the example in FIG. 17, the first printing unit 3a is located in the negative X-direction as the third direction from the first-A light irradiator 1a. The second printing unit 3b is located in the negative X-direction as the third direction from the first-B light irradiator 1b. The third printing unit 3c is located in the negative X-direction as the third direction from the first-C light irradiator 1c.

Each of the printing units 3 is, for example, an inkjet (IJ) head that ejects an ink 5. The ink 5 is photocurable ink that is a photosensitive material. Photocurable ink is cured (or photocured) in response to irradiation with light in a specific wavelength range. Photocurable ink is, for example, ultraviolet curable ink (also referred to as UV ink) that is cured (photocured) in response to irradiation with ultraviolet light as light in a specific wavelength range.

Each of the printing units 3 ejects, for example, the ink 5 onto the upper surface of the print medium 4 being fed by the feeder 2 to apply the ink 5 on the upper surface of the print medium 4. The IJ head as the printing unit 3 ejects, for example, droplets of the ink 5 onto the upper surface of the print medium 4 being fed by the feeder 2 to apply the droplets of the ink 5 on the upper surface of the print medium 4. For example, the printing unit 3 can apply the ink 5 to the upper surface of the print medium 4 in an intended pattern. The printing unit 3 may apply the ink 5 to, for example, substantially the entire upper surface of the print medium 4 or a part of the upper surface of the print medium 4.

The first printing unit 3a ejects, for example, a first type of ink (also referred to as a first ink) 5a onto the upper surface of the print medium 4 being fed by the feeder 2 to apply the first ink 5a to the upper surface of the print medium 4. The first ink 5a is, for example, ink of a first color. The first ink 5a may be a first UV ink as the ink of the first color. The first color may be, for example, cyan (C).

The second printing unit 3b ejects, for example, a second type of ink (also referred to as a second ink) 5b onto the upper surface of the print medium 4 being fed by the feeder 2 to apply the second ink 5b to the upper surface of the print medium 4. The second ink 5b may be, for example, ink of a second color. The second ink 5b may be a second UV ink as the ink of the second color. The second color may be, for example, magenta (M).

The third printing unit 3c ejects, for example, a third type of ink (also referred to as a third ink) 5c onto the upper surface of the print medium 4 being fed by the feeder 2 to apply the third ink 5c to the upper surface of the print medium 4. The third ink 5c may be, for example, ink of a third color. The third ink 5c may be a third UV ink as the ink of the third color. The third color may be, for example, yellow (Y).

The fourth printing unit 3d ejects, for example, a fourth type of ink (also referred to as a fourth ink) 5d onto the upper surface of the print medium 4 being fed by the feeder 2 to apply the fourth ink 5d to the upper surface of the print medium 4. The fourth ink 5d may be, for example, ink of a fourth color. The fourth ink 5d may be a fourth UV ink as the ink of the fourth color. The fourth color may be, for example, black (K).

For example, the first color may be any of cyan, magenta, yellow, or black. For example, the second color may be any of cyan, magenta, yellow, or black different from the first color. For example, the third color may be any of cyan, magenta, yellow, or black different from the first color and the second color. For example, the fourth color may be any of cyan, magenta, yellow, or black different from the first color, the second color, and the third color.

The IJ heads as the printing units 3 may be, for example, line IJ heads. Each of the line IJ heads includes multiple ink ejection orifices arrayed linearly. The line IJ head can eject the ink 5 from each of the multiple ink ejection orifices. A direction (also referred to as an array direction) in which the multiple ink ejection orifices are arrayed is, for example, a direction perpendicular to the feed direction of the print medium 4 fed by the feeder 2 and parallel to the upper surface of the print medium 4 being fed by the feeder 2. In other words, the array direction of the multiple ink ejection orifices may be the width direction of the print medium 4 perpendicular to the feed direction of the print medium 4 being fed by the feeder 2. In the example in FIG. 17, the array direction of the multiple ink ejection orifices is the positive Y-direction. In this structure, the inks 5 are ejected from the multiple ink ejection orifices in the line IJ heads onto the print medium 4 being fed by the feeder 2 in the feed direction to be applied to the upper surface of the print medium 4. The printing units 3 can thus print on the upper surface of the print medium 4.

The IJ heads as the printing units 3 may be, for example, another type of IJ heads such as serial IJ heads different from the line IJ heads. The serial IJ heads are movable in the width direction of the print medium 4. In this case, printing on the upper surface of the print medium 4 while the serial IJ heads are moving in the width direction of the print medium 4 alternates with feeding of the print medium 4 in the feed direction performed by the feeder 2. The printing units 3 can thus print on the upper surface of the print medium 4.

### First Light Irradiator 1

The first light irradiators 1 can irradiate the print medium 4 being fed by the feeder 2 in the feed direction with light through the first opening 140a. The first light irradiators 1 are located downstream from the respective printing units 3 in the feed direction in which the print medium 4 is fed by the feeder 2. The first outer surfaces 14a of the first light irradiators 1 face downward.

As described above, the light irradiator 1 can have higher cooling performance without including a cooling fan. This can reduce the likelihood of turbulence that may be forcibly caused by, for example, a cooling fan. This can reduce, in the printing apparatus 100, the effect of turbulence on, for example, the printing units 3 ejecting the inks 5 onto the upper surface of the print medium 4 and droplets of the inks 5 reaching the upper surface of the print medium 4. The printing units 3 and the first light irradiators 1 can be arranged close to each other. The printing apparatus 100 can thus be smaller.

In the example in FIG. 17, the first light irradiators 1 can irradiate the upper surface of the print medium 4 with light through the first openings 140a in the first outer surfaces 14a facing downward. In FIG. 17, an outer edge of light from each of the first light irradiators 1 toward the upper surface of the print medium 4 is schematically illustrated by the dot-dash lines. When the inks 5 are photocurable ink and light applied to the upper surface of the print medium 4 by the first light irradiators 1 is in a specific wavelength to cause photocurable ink to be cured (photocured), the inks 5 applied to the upper surface of the print medium 4 can be cured with the light from the first light irradiators 1. When, for example, the inks 5 are ultraviolet curable ink (UV ink) and light applied to the upper surface of the print medium 4 by the first light irradiators 1 is ultraviolet light in a specific wavelength range, the UV ink as the inks 5 applied to the upper surface of the print medium 4 can be cured.

When, for example, the first ink 5a is photocurable ink, the first-A light irradiator 1a irradiates, with light in a specific wavelength range, the first ink 5a applied to the upper surface of the print medium 4 by the first printing unit 3a, thus allowing the first ink 5a applied to the upper surface of the print medium 4 to be cured.

When, for example, the second ink 5b is photocurable ink, the first-B light irradiator 1b irradiates, with light in a specific wavelength range, the second ink 5b applied to the upper surface of the print medium 4 by the second printing unit 3b, thus allowing the second ink 5b applied to the upper surface of the print medium 4 to be cured.

When, for example, the third ink 5c is photocurable ink, the first-C light irradiator 1c irradiates, with light in a specific wavelength range, the third ink 5c applied to the upper surface of the print medium 4 by the third printing unit 3c, thus allowing the third ink 5c applied to the upper surface of the print medium 4 to be cured.

When, for example, the housings 14 of the first light irradiators 1 are thin rectangular prisms as described above, the first light irradiators 1 can be arranged in spaces between the four printing units 3 in the feed direction of the print medium 4 fed by the feeder 2. In this example, the housings 14 of the first light irradiators 1 may have their thickness direction in the feed direction of the print medium 4 fed by the feeder 2. Note that, in the example illustrated in FIG. 17, with reference to the positive X-direction as the second direction, the first light irradiators 1 (at least one of the first-A light irradiator 1a, the first-B light irradiator 1b, or the first-C light irradiator 1c) are arranged with the third outer surfaces 14c facing in the negative X-direction, the fourth outer surfaces 14d facing in the positive X-direction, and the direction from the third outer surfaces 14c to the fourth outer surfaces 14d being the second direction, but the arrangement may be reversed. More specifically, with reference to the positive X-direction as the second direction, the first light irradiators 1 (at least one of the first-A light irradiator 1a, the first-B light irradiator 1b, or the first-C light irradiator 1c) may be arranged with the fourth outer surfaces 14d facing in the negative X-direction, the third outer surfaces 14c facing in the positive X-direction, and the direction from the fourth outer surfaces 14d to the third outer surfaces 14c being the second direction. Thus, for the light irradiators 1, the second direction may be the thickness direction of the housing 14 either from the third outer surfaces 14c to the fourth outer surfaces 14d or from the fourth outer surfaces 14d to the third outer surfaces 14c. In other words, the feeder 2 may feed the print medium 4 irradiated with light through the first openings 140a in the second direction either from the third outer surfaces 14c to the fourth outer surfaces 14d or from the fourth outer surfaces 14d to the third outer surfaces 14c.

### Second Light Irradiator 6

The second light irradiator 6 can irradiate, with light, the print medium 4 being fed by the feeder 2 in the feed direction. In the example in FIG. 17, the second light irradiator 6 emits light downward to irradiate, with the light, the upper surface of the print medium 4. In FIG. 17, an outer edge of light from the second light irradiator 6 toward the upper surface of the print medium 4 is schematically illustrated by the dot-dash lines. When the inks 5 are photocurable ink and light applied to the upper surface of the print medium 4 by the second light irradiator 6 is in a specific wavelength range to cause photocurable ink to be cured (photocured), the inks 5 applied to the upper surface of the print medium 4 can be cured with the light from the second light irradiator 6. When, for example, the inks 5 are ultraviolet curable ink (UV ink) and light applied to the upper surface of the print medium 4 by the second light irradiator 6 is ultraviolet light in a specific wavelength range, the inks 5 applied to the upper surface of the print medium 4 can be cured.

The intensity of light in a specific wavelength range emitted from the second light irradiator 6 may be greater than the intensity of light in a specific wavelength range emitted from the first light irradiators 1. In this case, when the inks 5 are photocurable ink, the inks 5 applied to the upper surface of the print medium 4 may be substantially cured (or precured) with light in a specific wavelength range emitted from the first light irradiators 1 and further cured (or fully cured) with light in a specific wavelength range emitted from the second light irradiator 6.

The printing apparatus 100 in the example in FIG. 17 can operate as described below when the inks 5 are photocurable ink. First, the first printing unit 3a applies droplets of the first ink 5a to the upper surface of the print medium 4. The first-A light irradiator 1a then emits light in a specific wavelength range toward the upper surface of the print medium 4, causing the droplets of the first ink 5a applied to the upper surface of the print medium 4 to be precured. The second printing unit 3b then applies droplets of the second ink 5b to the upper surface of the print medium 4. The first-B light irradiator 1b then emits light in a specific wavelength range toward the upper surface of the print medium 4, causing the droplets of the second ink 5b applied to the upper surface of the print medium 4 to be precured. The third printing unit 3c then applies droplets of the third ink 5c to the upper surface of the print medium 4. The first-C light irradiator 1c then emits light in a specific wavelength range toward the upper surface of the print medium 4, causing the droplets of the third ink 5c applied to the upper surface of the print medium 4 to be precured. The fourth printing unit 3d then applies droplets of the fourth ink 5d to the upper surface of the print medium 4. The second light irradiator 6 then emits light in a specific wavelength range toward the upper surface of the print medium 4. This causes the droplets of the first ink 5a, the second ink 5b, and the third ink 5c that have been precured on the upper surface of the print medium 4 to be fully cured and the droplets of the fourth ink 5d applied to the upper surface of the print medium 4 to be cured.

In the above operation, the droplets of the second ink 5b are applied after the droplets of the first ink 5a are substantially cured on the upper surface of the print medium 4. This can reduce the likelihood that the droplets of the first ink 5a and the second ink 5b come in contact with each other and thus the first ink 5a and the second ink 5b are mixed on the upper surface of the print medium 4. The droplets of the third ink 5c are applied after the droplets of the first ink 5a and the second ink 5b are substantially cured on the upper surface of the print medium 4. This can reduce the likelihood that the droplets of the first ink 5a, the second ink 5b, and the third ink 5c come in contact with one another and thus the inks are mixed on the upper surface of the print medium 4. The droplets of the fourth ink 5d are applied after the droplets of the first ink 5a, the second ink 5b, and the third ink 5c are substantially cured on the upper surface of the print medium 4. This can reduce the likelihood that the droplets of the first ink 5a, the second ink 5b, the third ink 5c, and the fourth ink 5d come in contact with one another and thus the inks are mixed on the upper surface of the print medium 4. The printing apparatus 100 is thus less likely to have defects such as ink blurring and color mixing on the upper surface of the print medium 4, improving the quality of printed ink patterns.

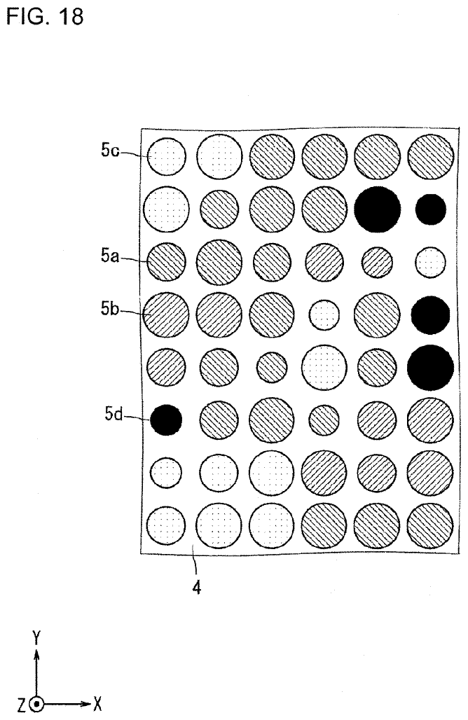

FIG. 18 is a schematic plan view of examples of four types of inks 5 applied to the upper surface of the print medium 4. In FIG. 18, droplets of the first ink 5a are indicated by the circles hatched with diagonal lines from the lower right to the upper left. Droplets of the second ink 5b are indicated by the circles hatched with diagonal lines from the lower left to the upper right. Droplets of the third ink 5c are indicated by the circles hatched with a dot pattern. Droplets of the fourth ink 5d are indicated by the solid circles.

### Controller 9

A controller 9 can control the operations of the components of the printing apparatus 100. The controller 9 includes, for example, various electrical circuits such as a processor and a memory. The controller 9 is, for example, electrically connected to each component of the printing apparatus 100 with a cable or other members. For example, the controller 9 may be electrically connected to the connectors 17 in the first light irradiators 1 with cables or other members. For example, the controller 9 may be electrically connected to a connector 67 in the second light irradiator 6 with a cable or other members. For example, the controller 9 may be electrically connected to the feeder 2 and the printing units 3 with cables or other members.

The controller 9 can control, for example, feeding of the print medium 4 performed by the feeder 2. The controller 9 can control, for example, ink ejection performed by the IJ heads as the printing units 3. The controller 9 can control, for example, light emission from each of the first light irradiators 1 and the second light irradiator 6.

When, for example, the inks 5 are photocurable ink, the memory in the controller 9 may store information indicating the properties of light relatively suitable for curing the inks 5 ejected from the IJ heads as the printing units 3. Examples of the information include numerical values representing the wavelength distribution characteristics and the intensity (the emission intensity for each wavelength range) of light suitable for curing droplets of the inks 5 ejected from the IJ heads. In the printing apparatus 100, for example, the controller 9 may adjust the level of a drive current to be input into the multiple light emitters 112 in the light sources 11 in the first light irradiators 1 based on the information in the memory. The first light irradiators 1 thus emit, for example, an appropriate amount of light based on the characteristics of the inks used. This allows the inks 5 to be cured with relatively low-energy light. The controller 9 may adjust the level of a drive current to be input into light emitters in the second light irradiator 6 based on the information in the memory.

### Size of First Light Irradiator

For example, the printing apparatus 100 is a line printer including, as the printing units 3, IJ heads having substantially the same width as the print medium 4. In this case, for example, the multiple first light irradiators 1 may be aligned in the positive Y-direction as the width direction of the print medium 4, and thus have a total width that is substantially the same as the width of the print medium 4. For example, the first dimension, the second dimension, and the third dimension of the first light irradiators 1 may each be set as appropriate to satisfy the conditions allowing the multiple first light irradiators 1 to have a total width that is substantially the same as the width of the print medium 4 in the positive Y-direction as the width direction of the print medium 4.

For example, multiple first-A light irradiators 1a may be aligned in the positive Y-direction as the width direction of the print medium 4, and thus have a total width that is substantially the same as the width of the print medium 4. For example, the first dimension, the second dimension, and the third dimension of the first-A light irradiators 1a may each be set as appropriate to satisfy the conditions allowing the multiple first-A light irradiators 1a to have a total width that is substantially the same as the width of the print medium 4 in the positive Y-direction as the width direction of the print medium 4.

For example, multiple first-B light irradiators 1b may be aligned in the positive Y-direction as the width direction of the print medium 4, and thus have a total width that is substantially the same as the width of the print medium 4. For example, the first dimension, the second dimension, and the third dimension of the first-B light irradiators 1b may each be set as appropriate to satisfy the conditions allowing the multiple first-B light irradiators 1b to have a total width that is substantially the same as the width of the print medium 4 in the positive Y-direction as the width direction of the print medium 4.

For example, multiple first-C light irradiators 1c may be aligned in the positive Y-direction as the width direction of the print medium 4, and thus have a total width that is substantially the same as the width of the print medium 4. For example, the first dimension, the second dimension, and the third dimension of the first-C light irradiators 1c may each be set as appropriate to satisfy the conditions allowing the multiple first-C light irradiators 1c to have a total width that is substantially the same as the width of the print medium 4 in the positive Y-direction as the width direction of the print medium 4.

### Fastening First Light Irradiator in Printing Apparatus

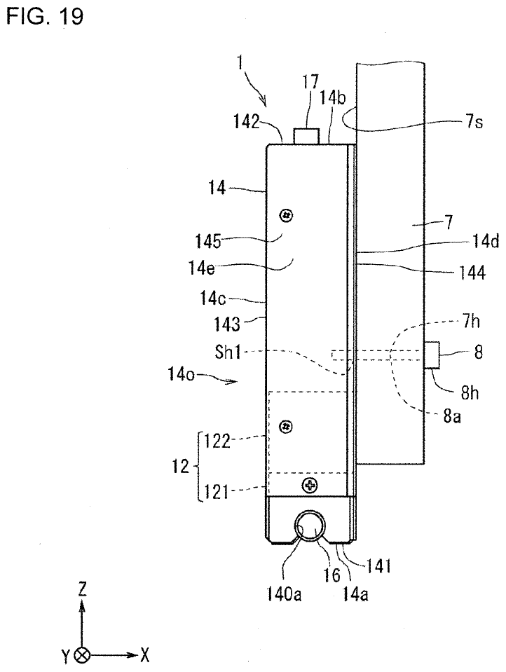

FIG. 19 is a front view of an example light irradiator (first light irradiator) 1 fastened to a mount 7 in the printing apparatus 100. In FIG. 19, the outer edges of the base 121 and one of the protrusions 122 in the heat dissipator 12 inside the light irradiator (first light irradiator) 1 are schematically illustrated by the thin dashed lines as hidden lines.

The printing apparatus 100 includes, for example, a portion (also referred to as the mount) 7 to which each of the first light irradiators 1 is fastened. The mount 7 may be fixed to, for example, a housing or a stand of the printing apparatus 100. The material for the mount 7 is, for example, a metal with high thermal conductivity such as aluminum or stainless steel. The mount 7 may be, for example, a thick plate.

Each of the first light irradiators 1 may be fastened to the mount 7 by, for example, screwing. In the example in FIG. 19, the mount 7 may be a thick plate portion including plate surfaces along an imaginary plane parallel to the YZ plane. An externally threaded member 8 including a shank 8a placed through a through-hole (also referred to as a first through-hole) 7h extending through the mount 7 in the negative X-direction may be fitted in a threaded hole Sh1 extending through the fourth wall 144 of the first light irradiator 1. The externally threaded member 8 may be a bolt including a head 8h and the shank 8a protruding from the head 8h. The shank 8a of the externally threaded member 8 may be an elongated cylinder including external helical threads on its outer periphery. The threaded hole Sh1 may be a portion including internal helical threads on the inner periphery of a through-hole. In this case, the mount 7 includes the first through-hole 7h, and the printing apparatus 100 includes the externally threaded member 8 fastening the first light irradiator 1 to the mount 7. In FIG. 19, the outer edge of each of the threaded hole Sh1, the first through-hole 7h, and the shank 8a is schematically illustrated by the thin dashed line as a hidden line. For example, the first through-hole 7h may be a threaded hole including internal helical threads on its inner periphery.

As illustrated in, for example, FIG. 3, the fourth wall 144 may include two threaded holes Sh1, and the mount 7 may include two first through-holes 7h. In this case, one externally threaded member 8 including the shank 8a placed through one of the first through-holes 7h extending through the mount 7 in the negative X-direction may be fitted in one of the threaded holes Sh1 extending through the fourth wall 144 of the first light irradiator 1. Another externally threaded member 8 including the shank 8a placed through the other of the first through-holes 7h extending through the mount 7 in the negative X-direction may be fitted in the other of the threaded holes Sh1 extending through the fourth wall 144 of the first light irradiator 1.

As described above, the first light irradiator 1 may be fastened to the mount 7 at multiple positions with multiple externally threaded members 8. This allows the first light irradiator 1 to be stably fastened in the printing apparatus 100. For example, the first light irradiator 1 may be fastened to the mount 7 at three or more positions with three or more externally threaded members 8.

The mount 7 may include, for example, an outer surface (also referred to as a seventh outer surface) 7s in surface contact with the fourth outer surface 14d of the housing 14 of the first light irradiator 1. When, for example, the housing 14 is in contact with the heat dissipator 12 in the first light irradiator 1, the heat dissipator 12 can be cooled more efficiently through heat transfer from the heat dissipator 12 to the mount 7 through the housing 14. Surface contact herein includes contact between flat surfaces. For example, the fourth outer surface 14d being in surface contact with the seventh outer surface 7s includes a flat portion of the fourth outer surface 14d being in contact with a flat portion of the seventh outer surface 7s.

For example, the first light irradiator 1 may be fastened to the mount 7 with a member different from the externally threaded member 8. The different member may fasten the first light irradiator 1 to the mount 7 by, for example, clamping. Specific examples of the different member include a clamp. The clamp may be, for example, fixed to the mount 7 and clamp the first light irradiator 1 or may clamp both the mount 7 and the first light irradiator 1 together to fasten the first light irradiator 1 to the mount 7.

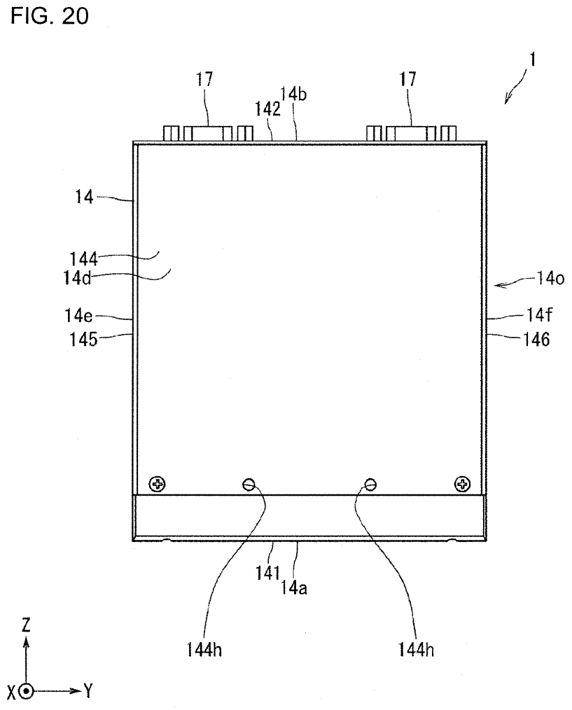

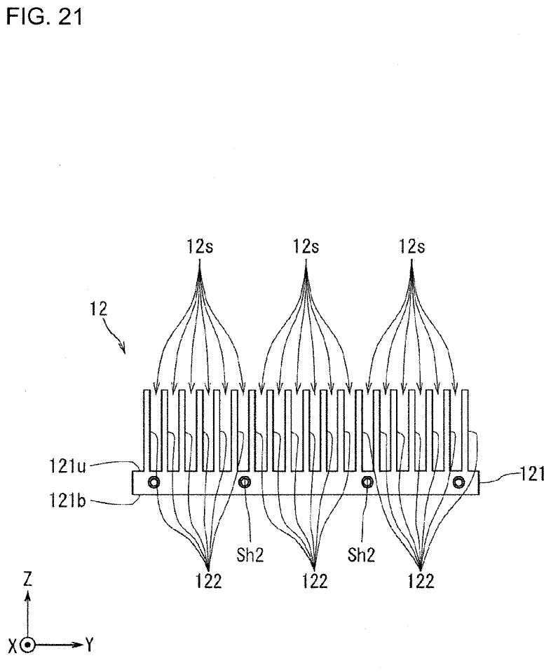

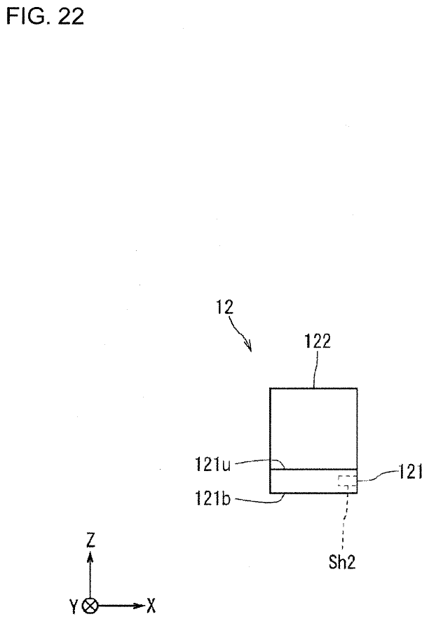

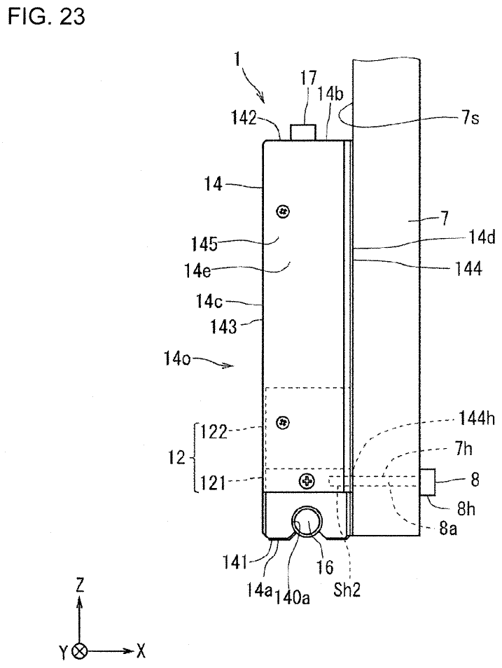

FIG. 20 is a right side view of a light irradiator (first light irradiator) 1 according to another example of the first embodiment, illustrating its appearance. FIG. 21 is a right side view of another example heat dissipator 12, illustrating its appearance. FIG. 22 is a front view of the other example heat dissipator 12, illustrating its appearance. FIG. 23 is a front view of another example light irradiator (first light irradiator) 1 fastened to the mount 7 in the printing apparatus 100. In FIG. 23, the outer edges of the base 121 and one of the protrusions 122 in the heat dissipator 12 inside the light irradiator (first light irradiator) 1 are schematically illustrated by the thin dashed lines as hidden lines.

As illustrated in, for example, FIGS. 21 and 22, the base 121 in the heat dissipator 12 in the first light irradiator 1 may include threaded holes Sh2 in its portion adjacent to the fourth outer surface 14d. In FIGS. 22 and 23, the outer edge of one of the threaded holes Sh2 is schematically illustrated by the thin dashed lines as hidden lines. Each of the threaded holes Sh2 may be, for example, a portion including internal helical threads on the inner periphery of a cylindrically recessed hole. Further, as illustrated in FIG. 20, the housing 14 of the first light irradiator 1 may include through-holes (also referred to as second through-holes) 144h that are open in the fourth outer surface 14d and connecting with the threaded holes Sh2. In FIG. 23, the outer edge of each of the first through-hole 7h, the second through-hole 144h, and the shank 8a is schematically illustrated by the thin dashed line as a hidden line. As illustrated in FIG. 23, the externally threaded member 8 may extend through the first through-hole 7h and the second through-hole 144h and be fitted in the threaded hole Sh2. More specifically, the shank 8a of the externally threaded member 8 may extend through the first through-hole 7h and the second through-hole 144h and be fitted in the threaded hole Sh2.

This structure allows the first light irradiator 1 to be easily fastened to the mount 7 with the fourth outer surface 14d of the housing 14 and the seventh outer surface 7s of the mount 7 in surface contact with each other. This may allow more heat to be transferred from the heat dissipator 12 to the mount 7 through the housing 14. The heat dissipator 12 may thus be efficiently cooled easily through heat transfer. When the material for the externally threaded member 8 is a metal with high thermal conductivity, the heat dissipator 12 may be cooled more efficiently. For example, the first through-hole 7h may be a threaded hole including internal helical threads on its inner periphery, and the second through-hole 144h may be a threaded hole including internal helical threads on its inner periphery.

As in the example in FIG. 20, for example, the fourth wall 144 may include two second through-holes 144h, and the mount 7 may include two first through-holes 7h. Further, as in the example in FIGS. 21 and 22, the base 121 may include one threaded hole Sh2 connecting with one of the second through-holes 144h and another threaded hole Sh2 connecting with the other of the second through-holes 144h.

In this case, for example, one externally threaded member 8 including the shank 8a extending through one of the first through-holes 7h extending through the mount 7 in the negative X-direction and one of the second through-holes 144h extending through the housing 14 in the negative X-direction may be fitted in one of the threaded holes Sh2 in the base 121. For example, another externally threaded member 8 including the shank 8a extending through the other of the first through-holes 7h extending through the mount 7 in the negative X-direction and the other of the second through-holes 144h extending through the housing 14 in the negative X-direction may be fitted in the other of the threaded holes Sh2 in the base 121.

As described above, the first light irradiator 1 may be fastened to the mount 7 at multiple positions with multiple externally threaded members 8. This allows the first light irradiator 1 to be stably fastened in the printing apparatus 100. For example, the first light irradiator 1 may be fastened to the mount 7 at three or more positions with three or more externally threaded members 8.

### 1-3. Overview of First Embodiment

In the light irradiator 1 according to the first embodiment, the second opening 140b is open in the area of the third outer surface 14c adjacent to the first outer surface 14a and connects the internal space 14i and the external space 140 of the housing 14. The third opening 140c is open in the area extending from the second outer surface 14b to the portion of the third outer surface 14c adjacent to the second outer surface 14b and connects the internal space 14i and the external space 140 of the housing 14. The heat dissipator 12 includes the base 121 located in the area adjacent to the first outer surface 14a in the internal space 14i and the multiple protrusions 122 each protruding from the base 121 toward the second outer surface 14b in the first direction. The light source 11 is located on the surface of base 121 adjacent to the first outer surface 14a. The multiple clearances 12s between the multiple protrusions 122 are adjacent to the second opening 140b. The drive 13 is located between the multiple protrusions 122 and the second outer surface 14b in the internal space 14i.

In this structure, when the first outer surface 14a faces downward, the third opening 140c extends from the second outer surface 14b facing upward to the upper portion of the third outer surface 14c. Thus, when the connectors 17 are on the second outer surface 14b, the third opening 140c may be large enough to discharge air from the internal space 14i to the external space 140 and have a long distance to the multiple protrusions 122. This may produce smooth updraft from the multiple clearances 12s between the multiple protrusions 122 toward the third opening 140c and also increase the velocity of the updraft by the stack effect. The heat dissipator 12 can thus be cooled efficiently. The light irradiator 1 can thus cool the heat dissipator 12 efficiently without including a cooling fan. The light irradiator 1 can thus be smaller and have a simpler structure and fewer failures, as well as can have higher cooling performance.

### 2. Other Embodiments

The present disclosure is not limited to the first embodiment described above and may be changed or varied in various manners without departing from the spirit and scope of the present disclosure.

In the first embodiment, for example, each of the multiple protrusions 122 in the heat dissipator 12 may not be a thin plate, and may be in any other shape such as a rod.

In the first embodiment, for example, a mesh component may be located in the second opening 140b. This can reduce entry of foreign matter into the internal space 14i from the external space 140 of the housing 14. Examples of the foreign matter may include dust, dirt, a metal component, and a tool.

In the first embodiment, for example, the external space 140 and the internal space 14i of the light irradiator 1 may be filled with a gas such as an inert gas, including a nitrogen gas, in place of air. In this case, the flow of air flowing from the external space 140 and passing through the second opening 140b, the internal space 14i, and the third opening 140c in this order to be discharged to the external space 140 is a flow of the gas.

In the first embodiment, for example, the printing apparatus 100 may include, in place of the four printing units 3, two or more printing units 3, such as three printing units 3. When the printing apparatus 100 includes, for example, three printing units 3, the fourth printing unit 3d and the first-C light irradiator 1c may be eliminated in the example in FIG. 17. In this case, for example, the first color, the second color, and the third color may be, for example, red (R), green (G), and blue (B). For example, the first color may be any of red (R), green (G), or blue (B). For example, the second color may be any of red (R), green (G), or blue (B) different from the first color. For example, the third color may be any of red (R), green (G), or blue (B) different from the first color and the second color.

In the first embodiment, for example, the printing apparatus 100 may include one or more first light irradiators 1 in place of the three first light irradiators 1. When the printing apparatus 100 includes, for example, three printing units 3, the fourth printing unit 3d and the first-C light irradiator 1c may be eliminated in the example in FIG. 17. When the printing apparatus 100 includes, for example, two printing units 3, the third printing unit 3c, the fourth printing unit 3d, the first-B light irradiator 1b, and the first-C light irradiator 1c may be eliminated in the example in FIG. 17.

In the first embodiment, for example, the IJ heads as the printing units 3 may each eject water- or oil-based ink as the ink 5 in place of the photocurable ink. In this case, for example, the first light irradiator 1 may irradiate the upper surface of the print medium 4 with light in a specific wavelength range, including infrared light, to dry and fix the inks 5 applied to the upper surface of the print medium 4.

In the first embodiment, for example, each of the printing units 3 may not include the IJ head, and may have another structure different from the IJ head. For example, the printing unit 3 may include an electrostatic head. The electrostatic head may charge the print medium 4 and electrostatically apply a developer (toner) to the print medium 4 charged with static electricity. The printing unit 3 may feed a developer (toner) with, for example, a brush or a roller. The developer may be, for example, an ultraviolet curable toner curable in response to irradiation with ultraviolet light or a heat curable toner curable in response to irradiation with infrared light.

In the first embodiment, for example, the ink 5 may be changed to a photoresist or a photocurable resin that is a photosensitive material.

In the first embodiment, the light irradiator 1 is used in, for example, the printing apparatus 100 including the printing units 3. However, the light irradiator 1 may be used in any other structure. For example, the light irradiator 1 may be used in an apparatus for applying a paste containing a photosensitive resin such as a resist to a target surface such as a substrate with spin coating or screen printing and then curing the photosensitive resin. For example, the light irradiator 1 may be used as a light source for exposure in an exposure apparatus that exposes a photosensitive resin such as a resist to light.

In the first embodiment, for example, the light irradiator 1 may not be used in, for example, the printing apparatus 100 and may be used in a structure in a field different from printing.

The light irradiator 1 may be used in, for example, assembly production including curing of adhesives or resins in electronic packaging. Curing of adhesives or resins may be substantial curing (precuring) of adhesives or resins. For example, an ultraviolet curable adhesive may be cured with ultraviolet light emitted from the light irradiator 1. For example, a heat curable adhesive may be cured with infrared light emitted from the light irradiator 1. For example, an adhesive curable by drying may be dried and cured with infrared light emitted from the light irradiator 1. For example, an ultraviolet curable resin curable in response to irradiation of ultraviolet light may be cured with ultraviolet light emitted from the light irradiator 1.

For example, the light irradiator 1 may be used in drying such as irradiating targets with infrared light for efficient drying. For example, the light irradiator 1 may be used in healthcare for, for example, sterilization with ultraviolet light or violet light.

The light irradiator 1 and the printing apparatus 100 have been described in detail, but the above structures are illustrative in all aspects, and the present disclosure is not limited to the above structures. The above embodiments may be combined in any manner unless any contradiction arises. Examples other than those illustrated above may also be included without departing from the scope of the present disclosure.

The present disclosure provides the structures described below.

In one embodiment, (1) a light irradiator includes a light source, a heat dissipator, a drive, and a housing being a rectangular prism. The light source includes a plurality of light emitters. The heat dissipator is thermally connected to the light source. The drive includes a drive circuit that drives the light source. The housing accommodates the light source, the heat dissipator, and the drive. The housing includes a first outer surface, a second outer surface, a third outer surface, a fourth outer surface, a fifth outer surface, and a sixth outer surface. The first outer surface is rectangular. The second outer surface is rectangular and opposite the first outer surface of the housing. The third outer surface is quadrangular and connects the first outer surface and the second outer surface of the housing. The fourth outer surface is quadrangular and opposite the third outer surface, and connects the first outer surface and the second outer surface of the housing. The fifth outer surface is rectangular, connects the first outer surface and the second outer surface of the housing, and connects the third outer surface and the fourth outer surface of the housing. The sixth outer surface is rectangular and opposite the fifth outer surface, connects the first outer surface and the second outer surface of the housing, and connects the third outer surface and the fourth outer surface of the housing. The housing includes a first opening, a second opening, and a third opening. The first opening is open at least in the first outer surface and allows light from the light source to pass through. The second opening is open in an area of the third outer surface adjacent to the first outer surface and connects an internal space and an external space of the housing. The third opening is open in an area extending from the second outer surface to a portion of the third outer surface adjacent to the second outer surface and connects the internal space and the external space. The heat dissipator includes a base and a plurality of protrusions. The base is in the internal space and adjacent to the first outer surface. The plurality of protrusions protrudes from the base toward the second outer surface in a first direction from the first outer surface to the second outer surface. The light source is located on a surface of the base adjacent to the first outer surface. A plurality of clearances between the plurality of protrusions is adjacent to the second opening. The drive is located between the plurality of protrusions and the second outer surface in the internal space.

(2) In the light irradiator according to (1), the second opening may have a dimension less than or equal to a dimension of the plurality of protrusions in the first direction. The plurality of clearances may include a portion adjacent to the base, and the portion may be adjacent to the second opening.

(3) In the light irradiator according to (2), the housing may include a first inner surface adjacent to the third outer surface in the internal space. The plurality of protrusions may include a portion adjacent to the second outer surface. The portion may be in contact with the first inner surface.

(4) In the light irradiator according to any one of (1) to (3), the drive circuit may include one or more electronic components. The one or more electronic components may be located between the second opening and the third opening in the first direction. The drive may be located in the internal space and closer to the fourth outer surface than to the third outer surface. The drive may have the one or more electronic components facing the third outer surface.

In one embodiment, (5) a printing apparatus includes the light irradiator according to any one of (1) to (4), a feeder, and a printing unit. The feeder feeds, in a second direction, a print medium to be irradiated with light through the first opening. The second direction is a direction from the third outer surface to the fourth outer surface or a direction from the fourth outer surface to the third outer surface. The printing unit is located farther in a third direction than the light irradiator. The third direction is opposite the second direction. The first outer surface faces downward.

(6) The printing apparatus according to (5) may further include a mount to which the light irradiator is fastened. The housing may be in contact with the heat dissipator. The mount may include a seventh outer surface in surface contact with the fourth outer surface of the housing.

(7) The printing apparatus according to (6) may further include an externally threaded member fastening the light irradiator to the mount. The mount may include a first through-hole. The base may include a threaded hole in a portion of the base adjacent to the fourth outer surface. The housing may include a second through-hole being open in the fourth outer surface and connecting with the threaded hole. The externally threaded member may extend through the first through-hole and the second through-hole and is fitted in the threaded hole.

1.-7. (canceled)

8. A light irradiator, comprising:
a light source;
a heat dissipator thermally connected to the light source;
a drive for driving the light source; and
a housing in which the light source, the heat dissipator, and the drive are arranged, wherein
the housing includes an inlet and an outlet,
the heat dissipator is adjacent to the inlet, and
the outlet and the drive are each located on an opposite side of the heat dissipator from the light source.

9. The light irradiator according to claim 8, wherein
no fan is disposed inside or outside the housing.

10. The light irradiator according to claim 8, wherein
the heat dissipator includes:
a base; and
a plurality of protrusions protruding opposite the light source from the base.

11. The light irradiator according to claim 10, wherein
the light source is in contact with the base.

12. The light irradiator according to claim 8, wherein
the outlet is located above the inlet.

13. The light irradiator according to claim 8, wherein
the housing includes:
a first surface having the inlet; and
a second surface facing the first surface, and
the heat dissipator is in contact with each of the first surface and the second surface.

14. The light irradiator according to claim 13, wherein
when a longitudinal direction of the inlet is a first direction, and a transverse direction of the inlet is a second direction, a length of the first surface in the second direction is greater than a length of the first surface in the first direction.

15. The light irradiator according to claim 14, wherein
a distance between the first surface and the second surface is smaller than each of the length of the first surface in the first direction and the length of the first surface in the second direction.

16. The light irradiator according to claim 13, wherein
the housing includes a third surface connecting the first surface and the second surface, and
the outlet extends from the first surface to the third surface.

17. A printing apparatus, comprising:
the light irradiator according to claim 8;
a mount to which the light irradiator is fastened; and
a printing unit that prints on a print medium, wherein
the housing is in contact with the mount.

18. A light irradiator, comprising:
a light source;
a heat dissipator thermally connected to the light source; and
a housing in which the light source and the heat dissipator are arranged, wherein
the housing includes:
a first surface;
a second surface facing the first surface;
an inlet in the first surface; and
an outlet in the first surface,
the heat dissipator is adjacent to the inlet and is in contact with each of the first surface and the second surface, and
the outlet is located on an opposite side of the heat dissipator from the light source.

19. The light irradiator according to claim 18, wherein
the heat dissipator includes:
a base; and
a plurality of protrusions protruding opposite the light source from the base.

20. The light irradiator according to claim 19, wherein
the light source is in contact with the base.

21. The light irradiator according to claim 18, wherein
the outlet is located above the inlet.

22. The light irradiator according to claim 18, wherein
when a longitudinal direction of the inlet is a first direction, and a transverse direction of the inlet is a second direction, a length of the first surface in the second direction is greater than a length of the first surface in the first direction.

23. The light irradiator according to claim 22, wherein
a distance between the first surface and the second surface is smaller than each of the length of the first surface in the first direction and the length of the first surface in the second direction.

24. The light irradiator according to claim 18, wherein
the housing includes a third surface connecting the first surface and the second surface, and
the outlet extends from the first surface to the third surface.

25. The light irradiator according to claim 18, further comprising
a drive for driving the light source, wherein
the drive is located between the first surface and the second surface and is located on an opposite side of the heat dissipator from the light source.

26. A printing apparatus, comprising:
the light irradiator according to claim 18;
a mount to which the light irradiator is fastened; and
a printing unit that prints on a print medium, wherein
the housing is in contact with the mount.
